(19) United States
(12) Patent Application Publication
(10) Pub. No.: US 2021/0201144 A1
(43) Pub. Date: Jul. 1, 2021

(54) SYSTEMS AND METHODS FOR ARTIFICIAL INTELLIGENCE ENHANCEMENTS IN AUTOMATED CONVERSATIONS

(71) Applicant: Conversica, Inc., Foster City, CA (US)

(72) Inventors: Siddhartha Reddy Jonnalagadda, Bothell, WA (US); Shubham Agarwal, Seattle, WA (US)

(21) Appl. No.: 17/115,577

(22) Filed: Dec. 8, 2020

Related U.S. Application Data
(60) Provisional application No. 62/955,326, filed on Dec. 30, 2019.

(51) Int. Cl. G06N 3/08; G06F 40/205; G06N 3/04

(52) U.S. Cl. CPC G06N 3/08; G06N 3/0445; G06F 40/205

(57) ABSTRACT

Systems and methods for generating custom client intents in an AI driven conversation system are provided. Additionally, systems and methods for contact updating in a conversation between an original contact and a dynamic messaging system is provided. Additional systems and methods allow for annotation of a response in a training desk. In additional embodiments, systems and methods for model deployment in a dynamic messaging system are provided. In yet additional embodiments, systems and methods for improved functioning of a dynamic messaging system are provided. Further, systems and methods for an automated buying assistant are provided. An additional set of embodiments include systems and methods for automated task completion.

### CROSS REFERENCE TO RELATED APPLICATION

This non-provisional application claims the benefit of U.S. provisional application No. 62/955,326, filed Dec. 30, 2019, same title, which application is incorporated herein in its entirety by this reference.

### BACKGROUND

The present invention relates to systems and methods for natural language processing and generation of more “human” sounding artificially generated conversations. Such natural language processing techniques may be employed in the context of machine learned conversation systems. These conversational AIs include, but are not limited to, message response generation, AI assistant performance, and other language processing, primarily in the context of the generation and management of a dynamic conversations. Such systems and methods provide a wide range of business people more efficient tools for outreach, knowledge delivery, automated task completion, and also improve computer functioning as it relates to processing documents for meaning. In turn, such system and methods enable more productive business conversations and other activities with a majority of tasks performed previously by human workers delegated to artificial intelligence assistants.

Artificial Intelligence (AI) is becoming ubiquitous across many technology platforms. AI enables enhanced productivity and enhanced functionality through “smarter” tools. Examples of AI tools include stock managers, chatbots, and voice activated search-based assistants such as Siri and Alexa. With the proliferation of these AI systems, however, come challenges for user engagement, quality assurance and oversight.

When it comes to user engagement, many people do not feel comfortable communicating with a machine outside of certain discrete situations. A computer system intended to converse with a human is typically considered limiting and frustrating. This has manifested in a deep anger many feel when dealing with automated phone systems, or spammed, non-personal emails.

These attitudes persist even when the computer system being conversed with is remarkably capable. For example, many personal assistants such as Siri and Alexa include very powerful natural language processing capabilities; however, the frustration when dealing with such systems, especially when they do not “get it” persists. Ideally an automated conversational system provides more organic sounding messages in order to reduce this natural frustration on behalf of the user. Indeed, in the perfect scenario, the user interfacing with the AI conversation system would be unaware that they are speaking with a machine rather than another human. In order for a machine to sound more human there is a need for improvements in natural language processing with AI learning.

It is therefore apparent that an urgent need exists for advancements in the natural language processing techniques used by AI conversation systems, including advanced transactional assistants. Such systems may allow for non-sequential conversations to meet specific organizational objectives with less required human input.

### SUMMARY

To achieve the foregoing and in accordance with the present invention, systems and methods for natural language processing, automated conversations, and enhanced system functionality are provided. Such systems and methods allow for more effective AI operations.

In some embodiments, a system and method for generating custom client intents in an AI driven conversation system are provided. In such systems and methods data for the client is received and a series of standard intent categories responsive to the client data are auto generated. A custom question is then received from the client, and intent categories are generated using at least one AI classification models, wherein the classifying calculates a percentage confidence of a match between the custom question and the intent categories. The classification results are then displayed along with the percentage confidence to the client. Feedback from the client to either merge the custom question with one of the standard intent categories or generate a new intent category is then received.

Merging the custom question with one of the standard intent categories updates the AI classification models as an additional training variant for machine learning. When the feedback is to create a new intent category, the system may generate the new intent category when the confidence percentage is below a threshold, and request a policy exception when the confidence percentage at or above the threshold. The policy exception requires policy review by a data scientist.

When a new category is generated, it requires the client to provide a dataset of variants for the new intent category as a dataset. The client is provided feedback when the dataset is sufficient, based upon at least one of the number of variants in the dataset, and the degree of factor difference between the various variants.

Additionally, a system and method for contact updating in a conversation between an original contact and a dynamic messaging system is provided. Such systems and methods receive a response message, classify it using at least one AI model. This classifying indicates the original contact is no longer with an organization, resulting in the deactivation of the lead's a record for the original contact, updating a conversation stage to ‘contact stopped’, updating a conversation status to ‘no longer with company’, and parsing the response message for an alternate contact information. When alternate contact information is present, the system sends a notification to a client user informing them that that the original contact is no longer with company and that alternate contact information was found. This new contact may then be validated, and messaged directly.

Additional systems and methods allow for annotation of a response in a training desk. Such systems and methods receive a response message in a conversation exchange, queue the response in a training desk, and display the response and annotation selections as global intents, variable intents and entities, to a user upon response selection from the queue. Feedback from the user is then received, and used to generate a transition for the conversation exchange responsive to the feedback. The transition is then confirmed with the user.

Global intents are available for all responses, and are mutually exclusive. Variable intents and entities are conversation exchange dependent and organized by an ontology. The variable intents and entities are not mutually exclusive.

In additional embodiments, systems and methods for model deployment in a dynamic messaging system are provided. These systems select a first set of responses that have been automatically classified by a current model from a corpus of responses, and a second set of responses that failed to be classified by the current model and required human classification from the corpus of responses. The system provides the first set and second set of messages to a reviewer, who provides a ‘true classifications’ for the first set and second set of messages. A new model is then trained using the corpus of responses minus the first and second set of responses. The first set and second set of responses are then classified using the new model. The new model is then deployed if the accuracy of these classifications is sufficient.

This sufficiency is determined by an accuracy measurement for the current model by comparing the classification of the first set of responses by the current model against the true classifications. This is compared against the accuracy measurement for the new model by comparing the classification of the first set of responses by the new model against the true classifications. An automation improvement score for the new model is generated by quantifying the number of the second set of responses that are classified by the new model without human input.

Training includes validation cross checks including automation rate, accuracy, F1 score, percentage of unacceptable matches, and a score custom to the model. Deployment occurs when the new model passes the validation cross checks, the accuracy of the new model is greater than the accuracy of the current model by a first threshold, and the automation improvement is greater than a second threshold. The deployment is passive for a set time period, and then replaces the current model with the new model after the set time period.

Training of the models includes weighting different classification sources differently when building the new model using machine learning. For example, the weight for a training desk classification alone is 1, a weight for an audit desk classification alone is 1, a weight for the training desk in agreement with the audit desk classification is 10, a weight for response feedback varies by severity between 10 to 20, a weight for an authority review is 50, and a weight for a hand-made training sample is 45.

In yet additional embodiments, systems and methods for improved functioning of a dynamic messaging system are provided. These systems and methods receive a response from a contact, apply a preprocessing model to detect and translate a language of the response, and apply a binary intent model to generate a response level intent for the preprocessed response. A similarity model is also applied to extract frequently asked questions and custom level intents from individual sentences of the preprocessed response. An entity model is used to extract named entities from the preprocessed response, and a multi-class model is applied to generate an action using the response level intent, sentence level intents and extracted named entities. The action may then be administered, and may include formulating a response.

The binary intent model, and multi-class model responsive to information regarding the contact, and the stage of a conversation exchange the response is in. For example, message cadence, message format, message content, language, and degree of persistence in the message are modified responsive to a stage of a conversation exchange the response is in. The system may also track attributes of the contact including age, gender, demographics, education level, geography, timestamping of communications, stage in business relationship and role, and similarly the message cadence, etc. may be modified accordingly.

Further, systems and methods for an automated buying assistant are provided. Such systems and methods generate at least one message to request information regarding requirements from a buyer. Once a response is received, the response is classified to extract requirements. The system generates at least one message to request information regarding product availability from a seller. A seller response is received, and is classified to extract availability information. The system then matches the requirements to the availability information responsive to criteria. The results of the matching are displayed to the buyer.

A confidence for the availability information, a confidence for the requirements, and a confidence for the matching are each calculated. When all three confidences are above some threshold an activity may be automatically completed. This activity could include setting up an appointment between the seller and the buyer, placing a product on hold, or completing a purchase for the product. The activity may further be responsive to a cost for a transaction defined by the requirements.

An additional set of embodiments include systems and methods for automated task completion. This may include receiving a task, extracting instructions for the task, and classifying the instructions using at least one AI model. A knowledge set is received, and the classification may be cross-referenced when at or above a threshold confidence to the knowledge set. The task is then completed when the cross-referencing yields a known answer in the knowledge set. Otherwise, a request for information is generated when the cross-referencing does not yield an answer in the knowledge set. The task is also displayed to a user when the classifying is below the threshold confidence.

The user can provide a response to the request for information. The response is then classified to yield the unknown answer, which is used to update the knowledge set, and complete the task.

Note that the various features of the present invention described above may be practiced alone or in combination. These and other features of the present invention will be described in more detail below in the detailed description of the invention and in conjunction with the following figures.

### BRIEF DESCRIPTION OF THE DRAWINGS

In order that the present invention may be more clearly ascertained, some embodiments will now be described, by way of example, with reference to the accompanying drawings, in which:

FIG. 1 is an example logical diagram of a system for generation and implementation of messaging conversations, in accordance with some embodiment;

FIG. 2 is an example logical diagram of a dynamic messaging server, in accordance with some embodiment;

FIG. 3 is an example logical diagram of a user interface within the dynamic messaging server, in accordance with some embodiment;

FIG. 4A is an example logical diagram of a message generator within the dynamic messaging server, in accordance with some embodiment;

FIG. 4B is an example logical diagram of an assistant manager within the message generator, in accordance with some embodiment;

FIG. 4C is an example logical diagram of an exchange transition server within the message generator, in accordance with some embodiment;

FIG. 4D is an example logical diagram of an message delivery server within the message generator, in accordance with some embodiment;

FIG. 5A is an example logical diagram of a message response system within the dynamic messaging server, in accordance with some embodiment;

FIG. 5B is an example logical diagram of the natural language processing server within the message response system, in accordance with some embodiment;

FIG. 5C is an example logical diagram of the AI modeler within the message response system, in accordance with some embodiment;

FIG. 5D is an example logical diagram of a model builder within the AI modeler, in accordance with some embodiment;

FIG. 6 is an example flow diagram for a dynamic message conversation, in accordance with some embodiment;

FIG. 7 is an example flow diagram for the process of on-boarding a business actor, in accordance with some embodiment;

FIG. 8 is an example flow diagram for the process of building a business activity such as conversation, in accordance with some embodiment;

FIG. 9 is an example flow diagram for the process of generating message templates, in accordance with some embodiment;

FIG. 10 is an example flow diagram for the process of implementing the conversation, in accordance with some embodiment;

FIG. 11 is an example flow diagram for the process of preparing and sending the outgoing message, in accordance with some embodiment;

FIG. 12 is an example flow diagram for the process of processing received responses, in accordance with some embodiment;

FIG. 13 is an example flow diagram for the process of document cleaning, in accordance with some embodiment;

FIG. 14 is an example flow diagram for classification processing, in accordance with some embodiment;

FIG. 15 is an example flow diagram for action setting, in accordance with some embodiment;

FIG. 16 is an example flow diagram for generating a natural language response, in accordance with some embodiment;

FIG. 17 is an example flow diagram for the selection of an appropriate response template, in accordance with some embodiment;

FIG. 18 is an example flow diagram for AI model generation and refinement, in accordance with some embodiment;

FIG. 19 is an example flow diagram for automatic robotic task completion, in accordance with some embodiment;

FIG. 20 is an example illustration of the state changes possible in a dynamic conversation, in accordance with some embodiment;

FIG. 21 is a first example illustration of an interface for FAQAA design, in accordance with some embodiment;

FIG. 22 is a second example illustration of an interface for FAQAA design, in accordance with some embodiment;

FIG. 23 is an example illustration of system response to a new contact being supplied, in accordance with some embodiment;

FIG. 24 is an example illustration of the transition interface of a new contact, in accordance with some embodiment;

FIG. 25 is an example illustration of the system notification to the contact update, in accordance with some embodiment;

FIG. 26 is an example illustration of a FAQAA evaluator interface, in accordance with some embodiment;

FIG. 27 is an example illustration of a conversation transition interface, in accordance with some embodiment;

FIG. 28 is an example illustration of a notification interface when a transition is applied, in accordance with some embodiment;

FIG. 29 is an example illustration of a conversation overview interface, in accordance with some embodiment; and

FIGS. 30A and 30B are example illustrations of a computer system capable of embodying the current invention.

### DETAILED DESCRIPTION

The present invention will now be described in detail with reference to several embodiments thereof as illustrated in the accompanying drawings. In the following description, numerous specific details are set forth in order to provide a thorough understanding of embodiments of the present invention. It will be apparent, however, to one skilled in the art, that embodiments may be practiced without some or all of these specific details. In other instances, well known process steps and/or structures have not been described in detail in order to not unnecessarily obscure the present invention. The features and advantages of embodiments may be better understood with reference to the drawings and discussions that follow.

Aspects, features and advantages of exemplary embodiments of the present invention will become better understood with regard to the following description in connection with the accompanying drawing(s). It should be apparent to those skilled in the art that the described embodiments of the present invention provided herein are illustrative only and not limiting, having been presented by way of example only. All features disclosed in this description may be replaced by alternative features serving the same or similar purpose, unless expressly stated otherwise. Therefore, numerous other embodiments of the modifications thereof are contemplated as falling within the scope of the present invention as defined herein and equivalents thereto. Hence, use of absolute and/or sequential terms, such as, for example, “will,” “will not,” “shall,” “shall not,” “must,” “must not,” “first,” “initially,” “next,” “subsequently,” “before,” “after,” “lastly,” and “finally,” are not meant to limit the scope of the present invention as the embodiments disclosed herein are merely exemplary.

The present invention relates to enhancements to traditional natural language processing techniques and subsequent actions taken by an automated system. While such systems and methods may be utilized with any AI system, such natural language processing particularly excel in AI systems relating to the generation of automated messaging for business conversations such as marketing and other sales functions. While the following disclosure is applicable for other combinations, we will focus upon natural language processing in AI marketing systems as an example, to demonstrate the context within which the enhanced natural language processing excels.

The following description of some embodiments will be provided in relation to numerous subsections. The use of subsections, with headings, is intended to provide greater clarity and structure to the present invention. In no way are the subsections intended to limit or constrain the disclosure contained therein. Thus, disclosures in any one section are intended to apply to all other sections, as is applicable.

The following systems and methods are for improvements in natural language processing and actions taken in response to such message exchanges, within conversation systems, and for employment of domain specific assistant systems that leverage these enhanced natural language processing techniques. The goal of the message conversations is to enable a logical dialog exchange with a recipient, where the recipient is not necessarily aware that they are communicating with an automated machine as opposed to a human user. This may be most efficiently performed via a written dialog, such as email, text messaging, chat, etc. However, given the advancement in audio and video processing, it may be entirely possible to have the dialog include audio or video components as well.

In order to effectuate such an exchange, an AI system is employed within an AI platform within the messaging system to process the responses and generate conclusions regarding the exchange. These conclusions include calculating the context of a document, intents, entities, sentiment and confidence for the conclusions. Human operators, through a “training desk” interface, cooperate with the AI to ensure as seamless an experience as possible, even when the AI system is not confident or unable to properly decipher a message, and through message annotation processes. The natural language techniques disclosed herein assist in making the outputs of the AI conversation system more effective, and more ‘human sounding’, which may be preferred by the recipient/target of the conversation.

### I. Dynamic Messaging Systems with Enhanced Natural Language Processing

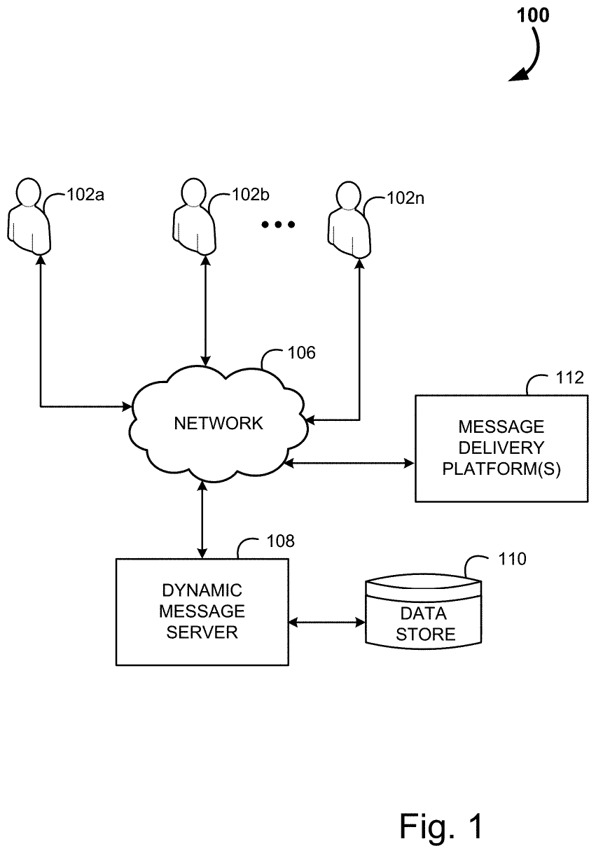

To facilitate the discussion, FIG. 1 is an example logical diagram of a system for generating and implementing messaging conversations, shown generally at 100. In this example block diagram, several users 102a-n are illustrated engaging a dynamic messaging system 108 via a network 106. Note that messaging conversations may be uniquely customized by each user 102a-n in some embodiments. In alternate embodiments, users may be part of collaborative sales departments (or other collaborative group) and may all have common access to the messaging conversations. The users 102a-n may access the network from any number of suitable devices, such as laptop and desktop computers, work stations, mobile devices, media centers, etc.

The network 106 most typically includes the internet but may also include other networks such as a corporate WAN, cellular network, corporate local area network, or combination thereof, for example. The messaging server 108 may distribute the generated messages to the various message delivery platforms 112 for delivery to the individual recipients. The message delivery platforms 112 may include any suitable messaging platform. Much of the present disclosure will focus on email messaging, and in such embodiments the message delivery platforms 112 may include email servers (Gmail, Yahoo, Outlook, etc.). However, it should be realized that the presently disclosed systems for messaging are not necessarily limited to email messaging. Indeed, any messaging type is possible under some embodiments of the present messaging system. Thus, the message delivery platforms 112 could easily include a social network interface, instant messaging system, text messaging (SMS) platforms, or even audio or video telecommunications systems.

One or more data sources 110 may be available to the messaging server 108 to provide user specific information, message template data, knowledge sets, intents, and target information. These data sources may be internal sources for the system's utilization or may include external third-party data sources (such as business information belonging to a customer for whom the conversation is being generated). These information types will be described in greater detail below. This information may be leveraged, in some embodiments, to generate a profile regarding the conversation target. A profile for the target may be particularly useful in a sales setting where differing approaches may yield dramatically divergent outcomes. For example, if it is known that the target is a certain age, with young children, and with an income of $75,000 per year, a conversation assistant for a car dealership will avoid presenting the target with information about luxury sports cars, and instead focus on sedans, SUVs and minivans within a budget the target is likely able to afford. By engaging the target with information relevant to them, and sympathetic to their preferences, the goals of any given conversation are more likely to be met. The external data sources typically relied upon to build out a target profile may include, but are not limited to, credit applications, CRM data sources, public records data sets, loyalty programs, social media analytics, and other “pay to play” data sets, for example.

The other major benefit of a profile for the target is that data that the system “should know” may be incorporated into the conversation to further personalize the message exchange. Information the system “should know” is data that is evident trough the exchange, or the target would expect the AI system would know. Much of the profile data may be public, but a conversation target would feel strange (or even violated) to know that the other party they are communicating with has such a full set of information regarding them. For example, a consumer doesn't typically assume a retailer knows how they voted in the last election, but through an AI conversational system with access to third party data sets, this kind of information may indeed be known. Bringing up such knowledge in a conversation exchange would strike the target as strange, at a minimum, and may actually interfere with achieving the conversation objectives. In contrast, offered information, or information the target assumes the other party has access to, can be incorporated into the conversation in a manner that personalizes the exchange, and makes the conversation more organic sounding. For example if the target mentions having children, and is engaging an AI system deployed for an automotive dealer, a very natural message exchange could include “You mentioned wanting more information on the Highlander SUV. We have a number in stock, and one of our sales reps would love to show you one and go for a test drive. Plus they are great for families. I'm sure your kids would love this car.”

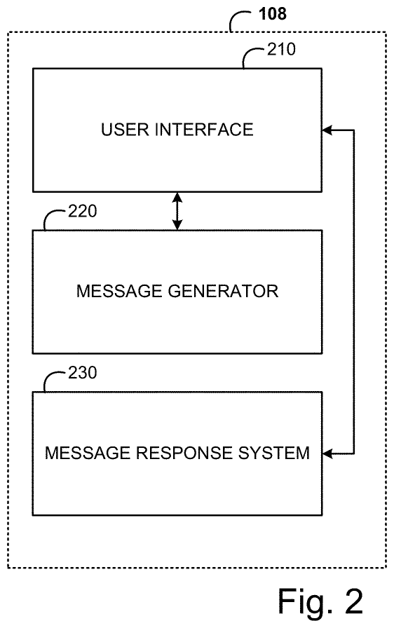

Moving on, FIG. 2 provides a more detailed view of the dynamic messaging server 108, in accordance with some embodiment. The server is comprised of three main logical subsystems: a user interface 210, a message generator 220, and a message response system 230. The user interface 210 may be utilized to access the message generator 220 and the message response system 230 to set up messaging conversations and manage those conversations throughout their life cycle. At a minimum, the user interface 210 includes APIs to allow a user's device to access these subsystems. Alternatively, the user interface 210 may include web accessible messaging creation and management tools.

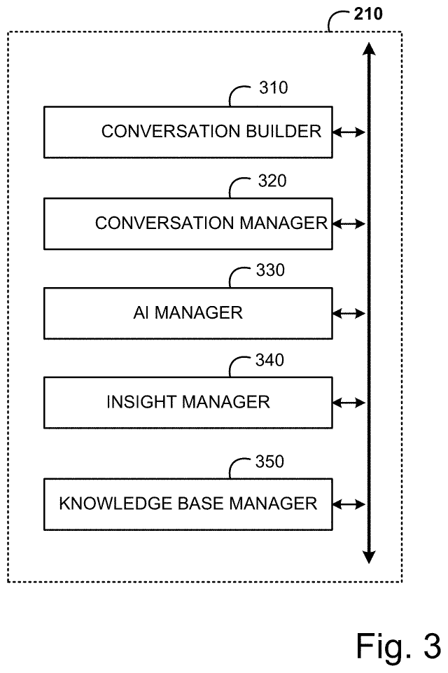

FIG. 3 provides a more detailed illustration of the user interface 210. The user interface 210 includes a series of modules to enable the previously mentioned functions to be carried out in the message generator 220 and the message response system 230. These modules include a conversation builder 310, a conversation manager 320 an AI manager 330, an intent manager 340, and a knowledge base manager 350.

The conversation builder 310 allows the user to define a conversation, and input message templates for each series/exchange within the conversation. A knowledge set and target data may be associated with the conversation to allow the system to automatically effectuate the conversation once built. Target data includes all the information collected on the intended recipients, and the knowledge set includes a database from which the AI can infer context and perform classifications on the responses received from the recipients.

The conversation manager 320 provides activity information, status, and logs of the conversation once it has been implemented. This allows the user 102a to keep track of the conversation's progress, success and allows the user to manually intercede if required. The conversation may likewise be edited or otherwise altered using the conversation manager 320.

The AI manager 330 allows the user to access the training of the artificial intelligence which analyzes responses received from a recipient. One purpose of the given systems and methods is to allow very high throughput of message exchanges with the recipient with relatively minimal user input. To perform this correctly, natural language processing by the AI is required, and the AI (or multiple AI models) must be correctly trained to make the appropriate inferences and classifications of the response message. The user may leverage the AI manager 330 to review documents the AI has processed and has made classifications for.

In some embodiments, the training of the AI system may be enabled by, or supplemented with, conventional CRM data. The existing CRM information that a business has compiled over years of operation is incredibly rich in detail, and specific to the business. As such, by leveraging this existing data set the AI models may be trained in a manner that is incredibly specific and valuable to the business. CRM data may be particularly useful when used to augment traditional training sets, and input from the training desk. Additionally, social media exchanges may likewise be useful as a training source for the AI models. For example, a business often engages directly with customers on social media, leading to conversations back and forth that are again, specific and accurate to the business. As such this data may also be beneficial as a source of training material.

The intent manager 340 allows the user to manage intents. As previously discussed, intents are a collection of categories used to answer some question about a document. For example, a question for the document could include “is the lead looking to purchase a car in the next month?” Answering this question can have direct and significant importance to a car dealership. Certain categories that the AI system generates may be relevant toward the determination of this question. These categories are the ‘intent’ to the question and may be edited or newly created via the intent manager 340. As will be discussed in greater detail below, the generation of questions and associated intents may be facilitated by leveraging historical data via a recommendation engine.

In a similar manner, the knowledge base manager 350 enables the management of knowledge sets by the user. As discussed, a knowledge set is a set of tokens with their associated category weights used by an aspect (AI algorithm) during classification. For example, a category may include “continue contact?”, and associated knowledge set tokens could include statements such as “stop”, “do no contact”, “please respond” and the like.

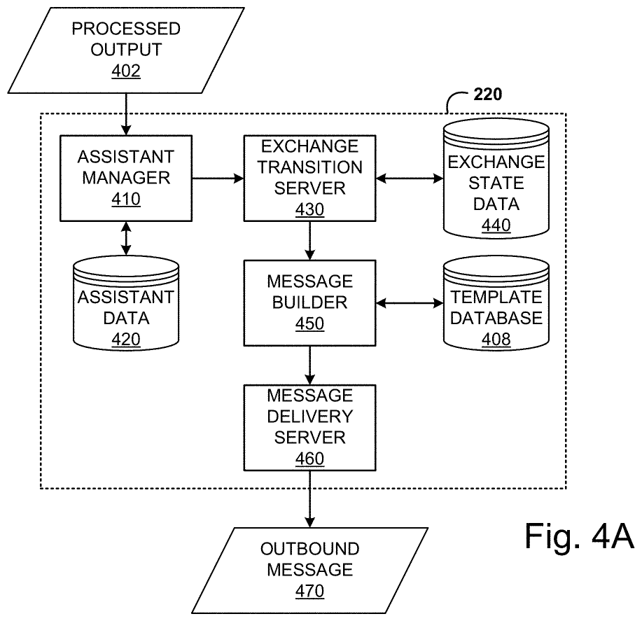

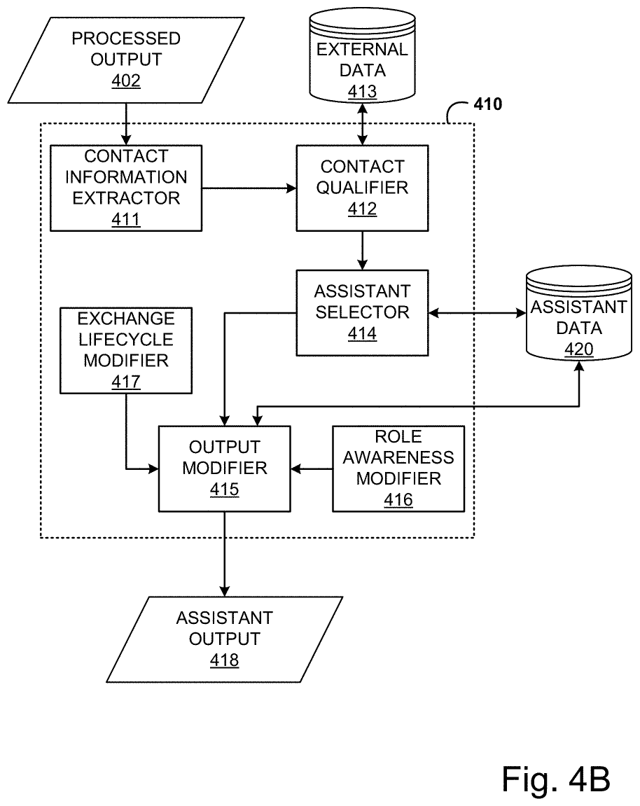

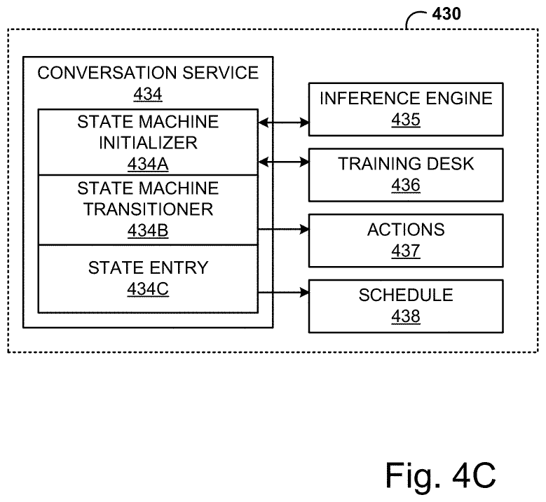

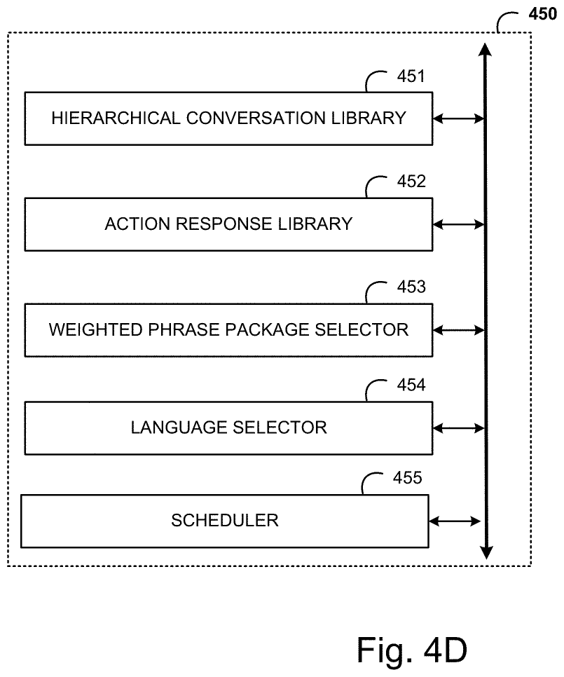

Moving on to FIG. 4A, an example logical diagram of the message generator 220 is provided. The message generator 220 utilizes context knowledge and target data to generate initial messages. In most cases however, the message generator 220 receives processed output 402 from the message response system 230 including intents of the last received response. This information is provided to an assistant manager 410, which leverages information about the various AI assistants form an assistant dataset 420. Different assistants may have access to differing permissions, as well as having domain specific datasets. For example, a sales assistant may have access to product information data that would not be readily available to a scheduling assistant. Likewise, different assistants, due to their domain specialty, may rely upon, or weight, the various action response models differently. For example, a sales assistant may react entirely differently from a customer service assistant given the same intent inputs.

Turning to FIG. 4B, greater detail of the specific components of the assistant manager 410 is provided. The initial activity of the assistant manager 410 is to identify and extract contract information from the processed output 402. A contact information extractor 411 identifies the contact information using syntactical analysis of the response. Statements such as “let me introduce you to”, “who I've cc'd on this email”, “please respond to”, and “contact” all indicate the presence of a new contact in the message. Of course the models used to identify new contact data includes many thousands of such phrases and variants thereof. Further information such as a new phone number, email contact or the like may additionally suggest that a new set of contact information is present in the response.

When a new contact is identified, this information is provided to a contact qualifier 412 which may access external data sources 413 to qualify the individual. This may include accessing company websites, social media sources (e.g., LinkedIn, etc.) and governmental databases (such as state registries of incorporated businesses, etc.). The contact qualifier 412 determines the authenticity and completeness of the contact information. For example, if a contact name is given for a company, but no email or phone number is provided, the contact qualifier 412 may access the company's website and perform a search for the individual's name. The results may be leveraged to fill in missing contact data.

After the contact extraction and qualification step, the processed output 402 is provided to an assistant selector 414 for actually determining which, if any, assistant is engaging with the contact in the present conversation. As noted before, assistant data 420 is leveraged to select which assistant is utilized, and the impact the particular assistant has on which action models should be applied.

An output modifier 415 takes this weighting of the action models to be applied, and combines it with two additional sources of response modification: that related to the conversation's stage, and modification based upon role awareness. The exchange lifecycle modifier 417 tracks the exchange maturity and augments the model weights accordingly, while the role awareness modifier 416 tracks the contact's role and likewise alters model weights to ensure the actions taken in response to the prior response insights are appropriate and best tailored to the assistant type, stage of the conversation, and the person the conversation is engaged with to achieve the goal(s) of the conversation. The final output of the output modifier 415 is the assistant output 418 which includes the weightings for the various models and/or features that can be incorporated into the action model.

Returning to FIG. 4A, after determining which assistant (or conversation) the processed output 402 is related to, the system undergoes a state transition. An exchange transition server 430 utilizes the exchange state data 440 in determining the initial state of the exchange/conversation, the applicable action model(s) to be applied, and thus calculates the correct state transition. As noted previously, weights for the various action models are altered by the assistant output 418. In some embodiments, the model variables themselves may be altered based upon this output.

The exchange transition server 430 includes a conversation service module 434. The conversation service module 434 may consist of a state machine initializer 434A that starts at an initial state and uses an inference engine 435 to determine which state to transition to. Particularly, the outputs of each of the models representing the state of the environment is shared with the agent in a reinforcement learning setting. The agent applies a policy to optimize a reward and decide upon an action. If the action is not inferred with a suitable threshold of confidence, an annotation platform requests annotation of sentence intents using active learning. In circumstances where the inference engine 435 is unsure of what state to transition to (due to a model confidence below an acceptable threshold), a training desk 436 may alternatively be employed. A state machine transitioner 434B updates the state from the initial state to an end state for the response. Actions 437 may result from this state transition. Actions may include webhooks, accessing external systems for appointment setting, or may include status updates. Once an action is done, it typically is a permanent event. A state entry 434C component may populate scheduling rows on a state entry once associated with a schedule 438.

Returning to FIG. 4A, after the actions have been determined, a message builder 450 incorporates the actions into a message template obtained from a template database 408 (when appropriate). Dynamic message building design depends on ‘message building’ rules in order to compose an outbound document. A rules child class is built to gather applicable phrase components for an outbound message. Applicable phrases depend on target variables and target state. FIG. 4D provides an example of this message builder 450, which is presented in greater detail. The message builder 450 receives output from the earlier components and performs its own processing to arrive at the final outgoing message. The message builder 450 may include a hierarchical conversation library 451 for storing all the conversation components for building a coherent message. The hierarchical conversation library 451 may be a large curated library, organized and utilizing multiple inheritance along a number of axes: organizational levels, access-levels (rep->group->customer->public). The hierarchical conversation library 451 leverages sophisticated library management mechanisms, involving a rating system based on achievement of specific conversation objectives, gamification via contribution rewards, and easy searching of conversation libraries based on a clear taxonomy of conversations and conversation trees.

In addition to merely responding to a message with a response, the message builder 450 may also include a set of actions that may be undertaken linked to specific triggers, these actions and associations to triggering events may be stored in an action response library 452. For example, a trigger may include “Please send me the brochure.” This trigger may be linked to the action of attaching a brochure document to the response message, which may be actionable via a webhook or the like. The system may choose attachment materials from a defined library (SalesForce repository, etc.), driven by insights gained from parsing and classifying the previous response, or other knowledge obtained about the target, client, and conversation. Other actions could include initiating a purchase (order a pizza for delivery for example) or pre-starting an ancillary process with data known about the target (kick of an application for a car loan, with name, etc. already pre-filled in for example). Another action that is considered is the automated setting and confirmation of appointments.

The message builder 450 may have a weighted phrase package selector 453 that incorporates phrase packages into a generated message based upon their common usage together, or by some other metric. Lastly, the message builder 450 may operate to select which language to communicate using a language selector 454. Rather than perform classifications using full training sets for each language, as is the traditional mechanism, the systems leverage dictionaries for all supported languages, and translations to reduce the needed level of training sets. In such systems, a primary language is selected, and a full training set is used to build a model for the classification using this language. Smaller training sets for the additional languages may be added into the machine learned model. These smaller sets may be less than half the size of a full training set, or even an order of magnitude smaller. When a response is received, it may be translated into all the supported languages, and this concatenation of the response may be processed for classification. The flip side of this analysis is the ability to alter the language in which new messages are generated. For example, if the system detects that a response is in French, the classification of the response may be performed in the above-mentioned manner, and similarly any additional messaging with this contact may be performed in French.

Determination of which language to use is easiest if the entire exchange is performed in a particular language. The system may default to this language for all future conversation. Likewise, an explicit request to converse in a particular language may be used to determine which language a conversation takes place in. However, when a message is not requesting a preferred language, and has multiple language elements, the system may query the user on a preferred language and conduct all future messaging using the preferred language.

A scheduler 455 used rules for messaging timing and learned behaviors in order to output the message at an appropriate time. For example, when emailing, humans generally have a latency in responding that varies from a few dozen minutes to a day or more. Having a message response sent out too quickly seems artificial. A response exceeding a couple of days, depending upon the context, may cause frustration, irrelevance, or may not be remembered by the other party. As such, the scheduler 455 aims to respond in a more ‘human’ timeframe and is designed to maximize a given conversation objective.

Returning to FIG. 4A, the compiled message and/or attendant actions are then provided to the message delivery server 460 to administer as an outbound message 470 in accordance with the scheduler's timeframe.

The message response system 230 receives the messages from the target/contact, and is tasked with processing the input message to yield a set of outputs. These outputs 402 include the intents, named entities, and additional metadata needed by the message generation system 220, as previously explained in considerable detail.

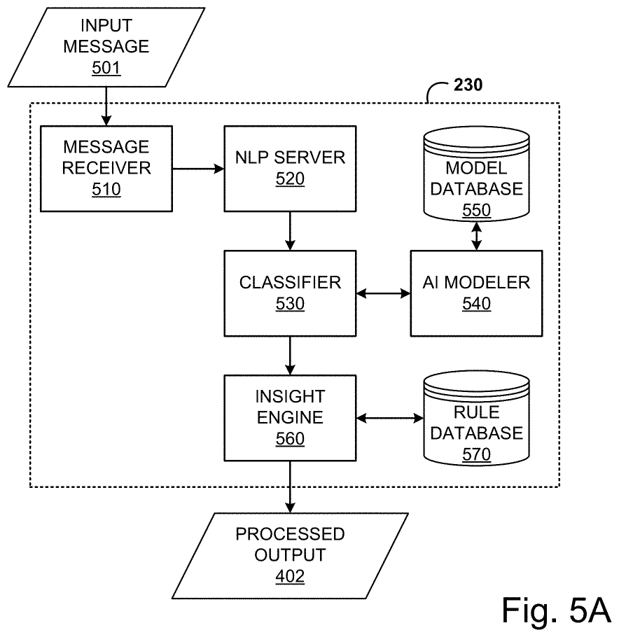

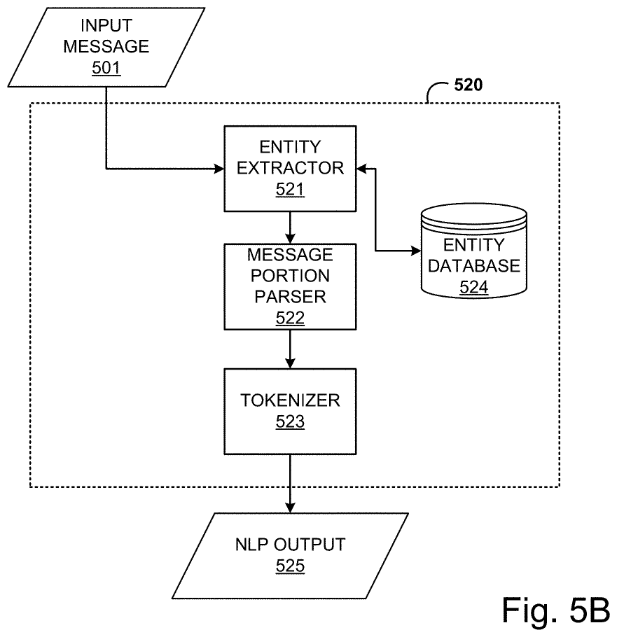

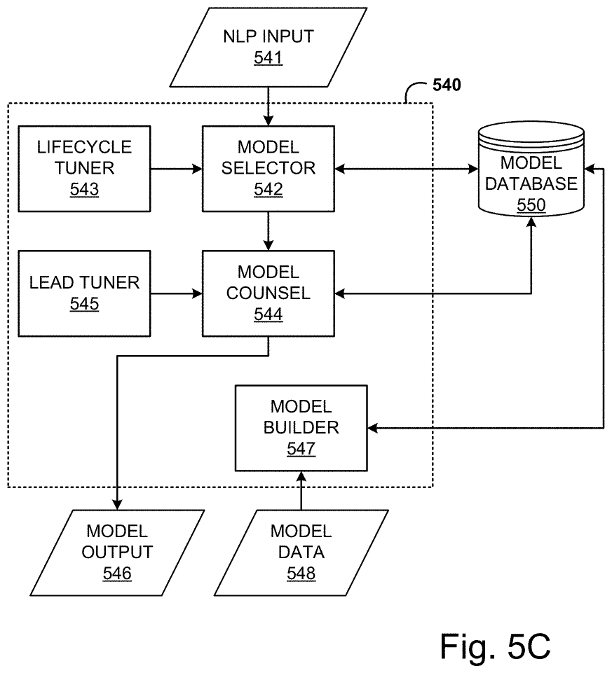

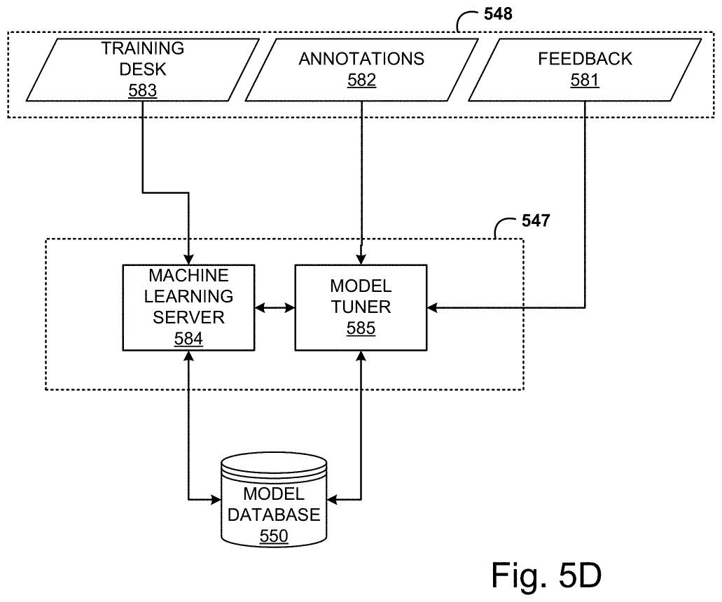

FIG. 5A is an example logical diagram of the message response system 230. In this example system, an input message 501 is initially received. As noted before, these input messages may be written in various platforms/formats, or may include audio or video inputs. Generally, the input messages are emails, and as such the following discussion will center upon this message type. Alternate input message formats may require additional pre-processing, such as transcription of an audio feed to a written format using voice recognition software, or the like. The inputted message is consumed by a message receiver 510 which may perform these needed pre-processing steps. The message handler may further perform document cleaning and error corrections.

Subsequently, the preprocessed message data is provided to a Natural Language Processor (NLP) server 520 for natural language analysis. This includes semantic analysis and entity recognition steps. FIG. 5B provides a more detailed view of this NLP server 520. The entity extractor 521 leverages known entity information from an entity database 524, in addition to neural network models (as will be discussed in greater detail below) to identify and replace known, and unknown, entity information with placeholder information. The NLP server 520 also performs tokenization by a tokenizer 523, parsing by a parser 522, and lemmatization. For example, the parser 522 consumes the raw message and splits it into multiple portions, including differentiating between the salutation, reply, close, signature and other message components, for example. Likewise, a tokenizer 523 may break the response into individual sentences and n-grams.

The section detection by the parser removes noise from the contact response, which allows for more accurate modeling. The pieces of the response that provide the desired features of the model typically reside within the message body. Salutations, closings and header information provide important information regarding contacts and conversation scope, but the response includes the majority of information desired for classification. The sections when identified and separated are annotated accordingly. The sections are labeled based upon indicator language, as well as location within the message.

Returning to FIG. 5A, the resulting NLP output 525 is provided to a classifier 530, which leverages AI models selected from a model database 550 by an AI modeler 540 to classify the responses. The AI modeler 540 is provided in greater detail in FIG. 5C. The NLP input 541 received via the classifier 530 is provided to a model selector 542 which has access to the model database 550. The model selector chooses a set of models form the dataset responsive to the type and stage of the conversation, as defined by a lifecycle tuner 543. Much like message generation, the stage of a conversation and the context of the exchange in significant in determining the intent of the message. By selection classification models that are context aware, in this manner, a more accurate classification is possible.

The model selector 542 provides its selected models to a model counsel 544 which performs the classification analysis on the input. The confidence levels for these classifications are used to select the model that is eventually output 546 to the classifier for usage. The model counsel 544 can utilize target information from a lead tuner 545 to modify the confidence levels of the resulting models. For example consider the following hypothetical: historically, for a specific individual, model A performs 20% better than model B. In the model counsel, the confidence for model A for classifying a response from this individual is found to be 87%, whereas model B is found to be 92% confident. Generally, model B would be selected as it has a higher confidence, but when adjusted for the fact that, historically, model A performs better for this individual, model A is chosen instead.

In addition to the model selection process, the AI modeler 540 uses training data and feedback data (collectively model data 548) to either build or update the various models stored in the model database 550 via a model builder 547. The model builder utilizes these training data sets to teach the models to be more accurate via known machine learning techniques. Details of the model builder 547 are provided in greater detail in relation to FIG. 5D. Here the model data 548 is shown to include the training desk feedback 583, annotations 582 supplied from human users, and additional feedback 581 data. This may include full training datasets than include human to human interactions. The training desk data 583 is used by a machine learning system 584 within the model builder 547 to generate new models within the model database 550. A model tune 585, in contrast, consumes the feedback and annotation data to adjust or update existing models.

Returning to FIG. 5A, the response data is subjected to natural language understanding (NLU) via machine learning neural network classifiers 530 using the models selected and presented by the AI modeler 540. The output of this classification system 530 includes intents and entity information. Both the entity extraction by the NLP server 520 and the intent extraction by the classifier 530 utilize a combination of rules and machine learned models to identify entities and intentions, respectively, found in the response. Particularly, an end-end neural approach is used where multiple components are stacked within a single deep neural network. These components include an encoder, a reasoner and a decoder. This differs from traditional AI systems which usually use a single speech recognition model, word-level analytics, syntactical parsing, information extractors, application reasoning, utterance planning, syntactic realization, text generation and speech synthesis.

In the present neural encoder, the encoding portion represents the natural language inputs and knowledge as dense, high-dimensional vectors using embeddings, such as dependency-based word embedding and bilingual word embeddings, as well as word representations by semi-supervised learning, semantic representations using conventional neural networks for web search, and parsing of natural scenes and natural language using recursive neural networks.

The reasoner portion of the neural encoder classifies the individual instance or sequence of these resulting vectors into a different instance or sequence typically using supervised approaches such as convolutional networks (for sentence classification) and recurrent networks (for the language model) and/or unsupervised approaches such as generative adversarial networks and auto-encoders (for reducing the dimensionality of data within the neural networks).

Lastly, the decoders of the neural encoder converts the vector outputs of the reasoner functions into symbolic space from which encoders originally created the vector representations. In some embodiments the neural encoder may include two functional tasks: natural language understanding (including intent classification and named entity recognition), and inference (which includes learning policies and implementation of these policies appropriate to the objective of the conversation system using reinforcing learning or a precomputed policy).

The network is extended to also represent sentences and paragraphs of the response in the vector space. These encodings are passed to a set of four models: named entities extraction, a recurrent neural network (RNN) classifying intents at paragraph-level, and a different recurrent neural network which uses the outputs of neural encoder and classifies the individual sentences into intents. The sentence-level intents and paragraph-level intents share the taxonomy but have a distinct set of labels. Fourth, a K-nearest neighbor algorithm is used on sentence representation to group semantically identical (or similar) sentences. When a cluster of semantically similar groups is big enough, the corresponding RNN model is trained via a trainer for the groups and creates a new sentence intent RNN network and add it the set of sentence intents if bias and variance are low.

The neural encoder accomplishes these tasks by automatically deriving a list of intents that that describe a conversational domain such that for every response from the user, the conversational AI system is able to predict how likely the user wanted to express intent, and the AI agent's policy can be evaluated using the intents and corresponding entities in the response to determine the agent's action. This derivation of intents uses data obtained from many enterprise assistant conversation flows. Each conversation flow was designed based on the reason for communication, the targeted goal and objectives, and key verbiage from the customer to personalize the outreach. These conversation flows are subdivided by their business functions (e.g., sales assistants selling automobiles, technology products, financial products and other products, service assistants, finance assistants, customer success assistants, collections assistants, recruiting assistants, etc.).

It should be noted that all machine learning NLP processes are exceptionally complicated and subject to frequent failure. Even for very well trained models, jargon and language usage develops over time, and differs between different contextual situation, thereby requiring continual improvement of the NLP systems to remain relevant and of acceptable accuracy. This results in the frequent need for human intervention in a conversation (a “human in the loop” or “HitL”). The major purpose of the dynamic message server 108 is the ability to have dynamic conversations with a variety of exchange states that may transition between all other exchange states (as opposed to serialized conversation flows). By allowing for these multi-nodal conversations, the system can be more responsive to the incoming messages; and through continual feature training and deployment, can significantly reduce the burden/need for human operators in the process.

### II. Methods

Now that the systems for dynamic messaging and natural language processing techniques have been broadly described, attention will be turned to processes employed to perform transactional assistant driven conversations.

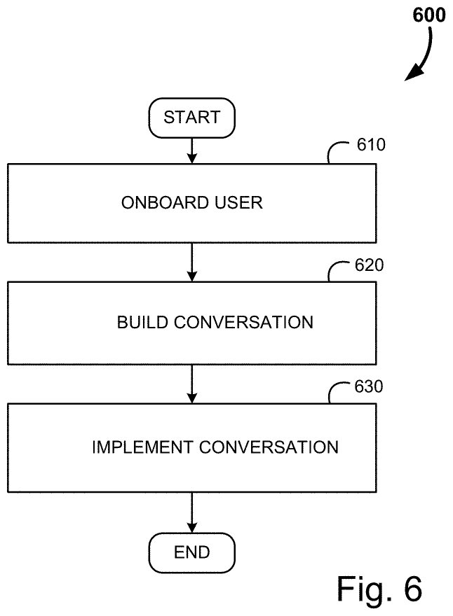

In FIG. 6 an example flow diagram for a dynamic message conversation is provided, shown generally at 600. The process can be broadly broken down into three portions: the on-boarding of a user (at 610), conversation generation (at 620) and conversation implementation (at 630). The following figures and associated disclosure will delve deeper into the specifics of these given process steps.

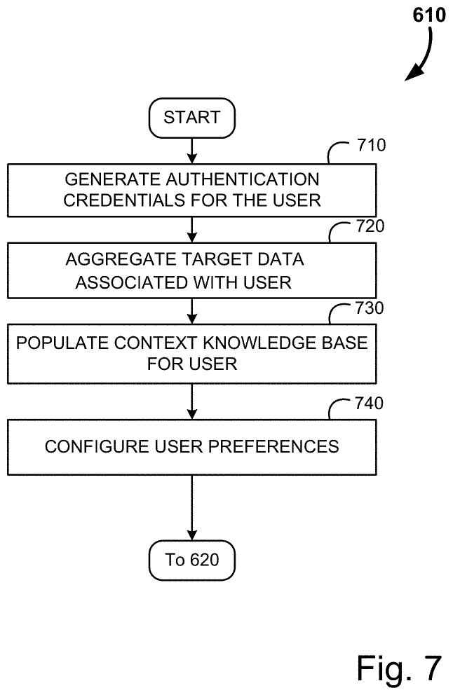

FIG. 7, for example, provides a more detailed look into the on-boarding process, shown generally at 610. Initially a user is provided (or generates) a set of authentication credentials (at 710). This enables subsequent authentication of the user by any known methods of authentication. This may include username and password combinations, biometric identification, device credentials, etc.

Next, the target data associated with the user is imported, or otherwise aggregated, to provide the system with a target database for message generation (at 720). Likewise, context knowledge data may be populated as it pertains to the user (at 730). Often there are general knowledge data sets that can be automatically associated with a new user; however, it is sometimes desirable to have knowledge sets that are unique to the user's conversation that wouldn't be commonly applied. These more specialized knowledge sets may be imported or added by the user directly.

Lastly, the user is able to configure their preferences and settings (at 740). This may be as simple as selecting dashboard layouts, to configuring confidence thresholds required before alerting the user for manual intervention.

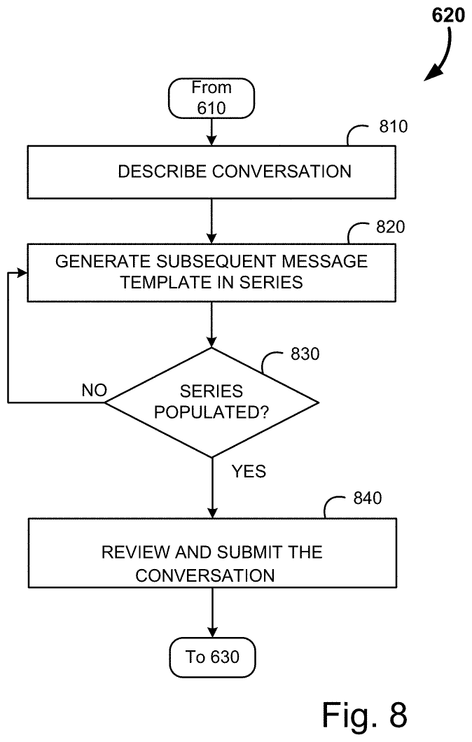

Moving on, FIG. 8 is the example flow diagram for the process of building a conversation, shown generally at 620. The user initiates the new conversation by first describing it (at 810). Conversation description includes providing a conversation name, description, industry selection, and service type. The industry selection and service type may be utilized to ensure the proper knowledge sets are relied upon for the analysis of responses.

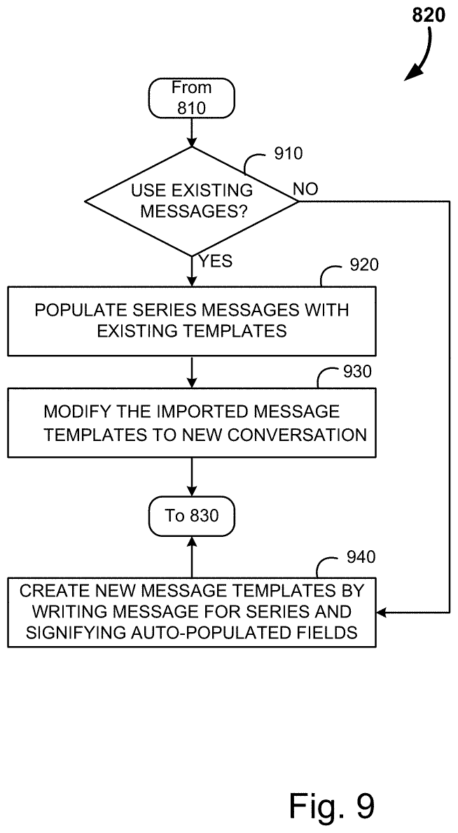

After the conversation is described, the message templates in the conversation are generated (at 820). If the exchanges in the conversation are populated (at 830), then the conversation is reviewed and submitted (at 840). Otherwise, the next message in the template is generated (at 820). FIG. 9 provides greater details of an example of this sub-process for generating message templates. Initially the user is queried if an existing conversation can be leveraged for templates, or whether a new template is desired (at 910).

If an existing conversation is used, the new message templates are generated by populating the templates with existing templates (at 920). The user is then afforded the opportunity to modify the message templates to better reflect the new conversation (at 930). Since the objectives of many conversations may be similar, the user will tend to generate a library of conversations and conversation fragments that may be reused, with or without modification, in some situations. Reusing conversations has time saving advantages, when it is possible.

However, if there is no suitable conversation to be leveraged, the user may opt to write the message templates from scratch using the a conversation editor (at 940). When a message template is generated, the bulk of the message is written by the user, and variables are imported for regions of the message that will vary based upon the target data. Successful messages are designed to elicit responses that are readily classified. Higher classification accuracy enables the system to operate longer without user interference, which increases conversation efficiency and user workload.

Messaging conversations can be broken down into individual objectives for each target. Designing conversation objectives allows for a smoother transition between messaging exchanges. Table 1 provides an example set of messaging objectives for an example sales conversation.

TABLE 1
Template Objectives
Objective
Verify Email Address
Obtain Phone Number
Introduce Sales Representative
Verify Rep Follow-Up

Likewise, conversations can have other arbitrary set of objectives as dictated by client preference, business function, business vertical, channel of communication and language. Objective definition can track the state of every target. Inserting personalized objectives allows immediate question answering at any point in the lifecycle of a target. The state of the conversation objectives can be tracked individually as shown below in reference to Table 2.

TABLE 2
Objective tracking

| Target | Conversation | | | | |
|---|---|---|---|---|---|
| ID | ID | Objective | Type | Pending | Complete |
| 100 | 1 | Verify Email Address | Q | 1 | 1 |
| 100 | 1 | Obtain Phone Number | Q | 0 | 1 |
| 100 | 1 | Give Location Details | I | 1 | 0 |
| 100 | 1 | Verify Rep Follow-Up | Q | 0 | 0 |

Table 2 displays the state of an individual target assigned to conversation 1, as an example. With this design, the state of individual objectives depends on messages sent and responses received. Objectives can be used with an informational template to make an exchange transition seamless. Tracking a target's objective completion allows for improved definition of target's state, and alternative approaches to conversation message building. Conversation objectives are not immediately required for dynamic message building implementation but become beneficial soon after the start of a conversation to assist in determining when to transition from one exchange to another.

Dynamic message building design depends on ‘message building’ rules in order to compose an outbound document. A Rules child class is built to gather applicable phrase components for an outbound message. Applicable phrases depend on target variables and target state.

To recap, to build a message, possible phrases are gathered for each template component in a template iteration. In some embodiment, a single phrase can be chosen randomly from possible phrases for each template component. Alternatively, as noted before, phrases are gathered and ranked by “relevance”. Each phrase can be thought of as a rule with conditions that determine whether or not the rule can apply and an action describing the phrase's content.

Relevance is calculated based on the number of passing conditions that correlate with a target's state. A single phrase is selected from a pool of most relevant phrases for each message component. Chosen phrases are then imploded to obtain an outbound message. Logic can be universal or data specific as desired for individual message components.

Variable replacement can occur on a per phrase basis, or after a message is composed. Post message-building validation can be integrated into a message-building class. All rules interaction will be maintained with a messaging rules model and user interface.

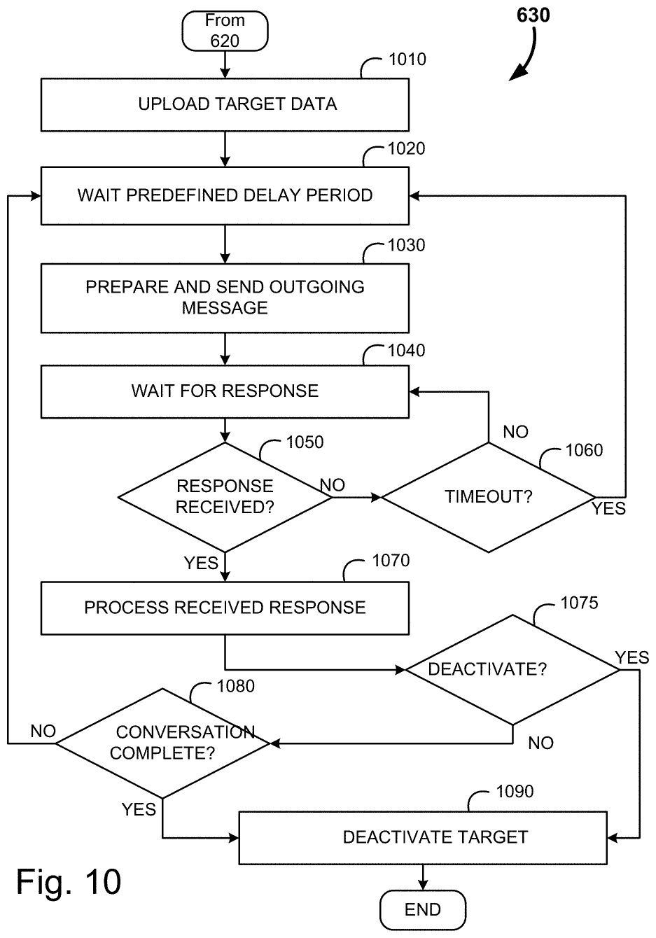

Once the conversation has been built out it is ready for implementation. FIG. 10 is an example flow diagram for the process of implementing the conversation, shown generally at 630. Here the lead (or target) data is uploaded (at 1010). Target data may include any number of data types, but commonly includes names, contact information, date of contact, item the target was interested in (in the context of a sales conversation), etc. Other data can include open comments that targets supplied to the target provider, any items the target may have to trade in, and the date the target came into the target provider's system. Often target data is specific to the industry, and individual users may have unique data that may be employed.

An appropriate delay period is allowed to elapse (at 1020) before the message is prepared and sent out (at 1030). The waiting period is important so that the target does not feel overly pressured, nor the user appears overly eager. Additionally, this delay more accurately mimics a human correspondence (rather than an instantaneous automated message). Additionally, as the system progresses and learns, the delay period may be optimized by a cadence optimizer to be ideally suited for the given message, objective, industry involved, and actor receiving the message.

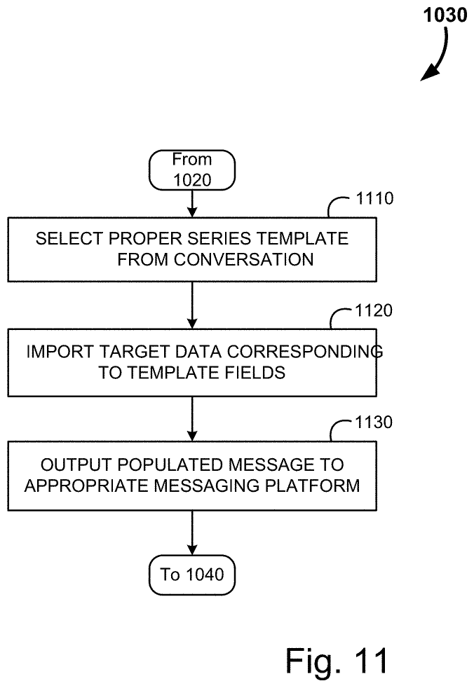

FIG. 11 provides a more detailed example of the message preparation and output. In this example flow diagram, the message within the series is selected based upon the source exchange and any NLU results via deterministic rules, or via models such as multi-armed bandit problem (at 1110). The initial message is generally deterministically selected based upon how the conversation is initiated (e.g., system reaching out to new customer, vs customer contacting the system, vs prior customer re-contact, etc.). Typically, if the recipient didn't respond as expected, or not at all, it may be desirous to have alternate message templates to address the target most effectively.

After the message template is selected, the target data is parsed through, and matches for the variable fields in the message templates are populated (at 1120). Variable filed population, as touched upon earlier, is a complex process that may employ personality matching, and weighting of phrases or other inputs by success rankings. These methods will also be described in greater detail when discussed in relation to variable field population in the context of response generation. Such processes may be equally applicable to this initial population of variable fields.

In addition, or alternate to, personality matching or phrase weighting, selection of wording in a response could, in some embodiments, include matching wording or style of the conversation target. People, in normal conversation, often mirror each other's speech patterns, mannerisms and diction. This is a natural process, and an AI system that similarly incorporates a degree of mimicry results in a more ‘humanlike’ exchange.

Additionally, messaging may be altered by the class of the audience (rather than information related to a specific target personality). For example, the system may address an enterprise customer differently than an individual consumer. Likewise, consumers of one type of good or service may be addressed in subtly different ways than other customers. Likewise, a customer service assistant may have a different tone than an HR assistant, etc.

The populated message is output to the communication channel appropriate messaging platform (at 1130), which as previously discussed typically includes an email service, but may also include SMS services, instant messages, social networks, audio networks using telephony or speakers and microphone, or video communication devices or networks or the like. In some embodiments, the contact receiving the messages may be asked if he has a preferred channel of communication. If so, the channel selected may be utilized for all future communication with the contact. In other embodiments, communication may occur across multiple different communication channels based upon historical efficacy and/or user preference. For example, in some particular situations a contact may indicate a preference for email communication. However, historically, in this example, it has been found that objectives are met more frequently when telephone messages are utilized. In this example, the system may be configured to initially use email messaging with the contact, and only if the contact becomes unresponsive is a phone call utilized to spur the conversation forward. In another embodiment, the system may randomize the channel employed with a given contact, and over time adapt to utilize the channel that is found to be most effective for the given contact.

Returning to FIG. 10, after the message has been output, the process waits for a response (at 1040). If a response is not received (at 1050) the process determines if the wait has been timed out (at 1060). Allowing a target to languish too long may result in missed opportunities; however, pestering the target too frequently may have an adverse impact on the relationship. As such, this timeout period may be user defined and will typically depend on the communication channel. Often the timeout period varies substantially, for example for email communication the timeout period could vary from a few days to a week or more. For real-time chat communication channel implementations, the timeout period could be measured in seconds, and for voice or video communication channel implementations, the timeout could be measured in fractions of a second to seconds. If there has not been a timeout event, then the system continues to wait for a response (at 1050). However, once sufficient time has passed without a response, it may be desirous to return to the delay period (at 1020) and send a follow-up message (at 1030). Often there will be available reminder templates designed for just such a circumstance.

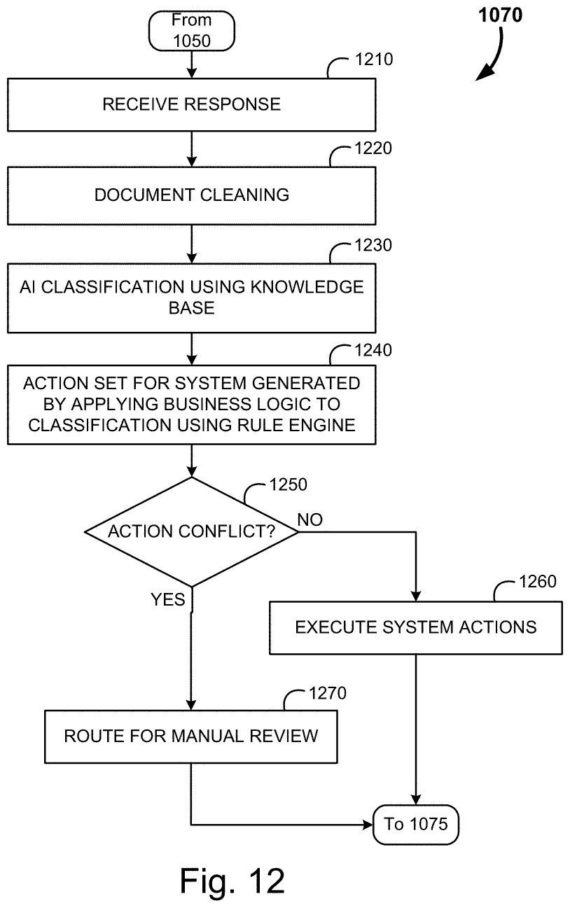

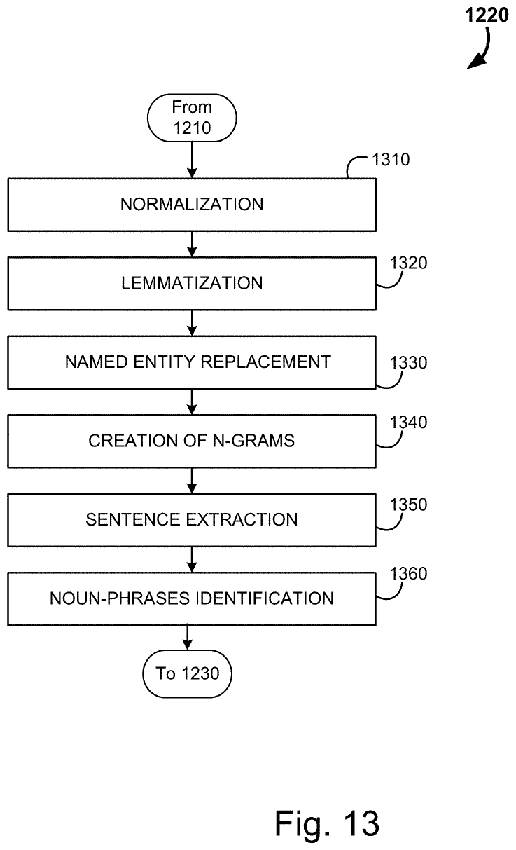

However, if a response is received, the process may continue with the response being processed (at 1070). This processing of the response is described in further detail in relation to FIG. 12. In this sub-process, the response is initially received (at 1210) and the document may be cleaned (at 1220). Document cleaning is described in greater detail in relation with FIG. 13. Upon document receipt, adapters may be utilized to extract information from the document for shepherding through the cleaning and classification pipelines. For example, for an email, adapters may exist for the subject and body of the response, often a number of elements need to be removed, including the original message, HTML encoding for HTML style responses, enforce UTF-8 encoding so as to get diacritics and other notation from other languages, and signatures so as to not confuse the AI. Only after all this removal process does the normalization process occur (at 1310) where characters and tokens are removed in order to reduce the complexity of the document without changing the intended classification.

After the normalization, documents are further processed through lemmatization (at 1320), name entity replacement (at 1330), the creation of n-grams (at 1340) sentence extraction (at 1350), noun-phrase identification (at 1360) and extraction of out-of-office features and/or other named entity recognition (at 1370). Each of these steps may be considered a feature extraction of the document. Historically, extractions have been combined in various ways, which results in an exponential increase in combinations as more features are desired. In response, the present method performs each feature extraction in discrete steps (on an atomic level) and the extractions can be “chained” as desired to extract a specific feature set.

Returning to FIG. 12, after document cleaning, the document is then provided to the classification system for intent classification using the knowledge sets/base (at 1230). For the purpose of this disclosure, a “knowledge set” is a corpus of domain specific information that may be leveraged by the machine learned classification models. The knowledge sets may include a plurality of concepts and relationships between these concepts. It may also include basic concept-action pairings. The AI Platform will apply large knowledge sets to classify ‘Continue Messaging’, ‘Do Not Email’ and ‘Send Alert’ insights. Additionally, various domain specific ‘micro-insights’ can use smaller concise knowledge sets to search for distinct elements in responses.

The classification may be referred to also as Natural Language Understanding (NLU), which results in the generation of classifications of the natural language and extracted entity information. Rules are used to map the classifications to intents of the language. Classifications and intents are derived via both automated machine learned models as well as through human intervention via annotations. In some embodiments, supervised learning with deep learning or machine learning techniques may be employed to generate the classification models and/or intent rules. Alternatively sentence similarity with TF-IDF (term frequency-inverse document frequency), word embedding similarity, Siamese networks and/or sentence encodings may be leveraged for the intent generation. More rudimentary, but suitable in some cases, pattern or exact matching may be also employed for intent determination. Additionally, external APIs may be leveraged in addition to, or instead of, internally derived methods for intent determination. Entity extraction may be completed using dictionary matches, recurrent neural networks (RNNs) regular expressions, open source third party extractors and/or external APIs. The results of the classification (intent and entity information) are then processed by the inference engine (IE) components of the transactional assistant to determine edge directionality for exchange transitions, and further for natural language generation (NLG) and/or other actions.

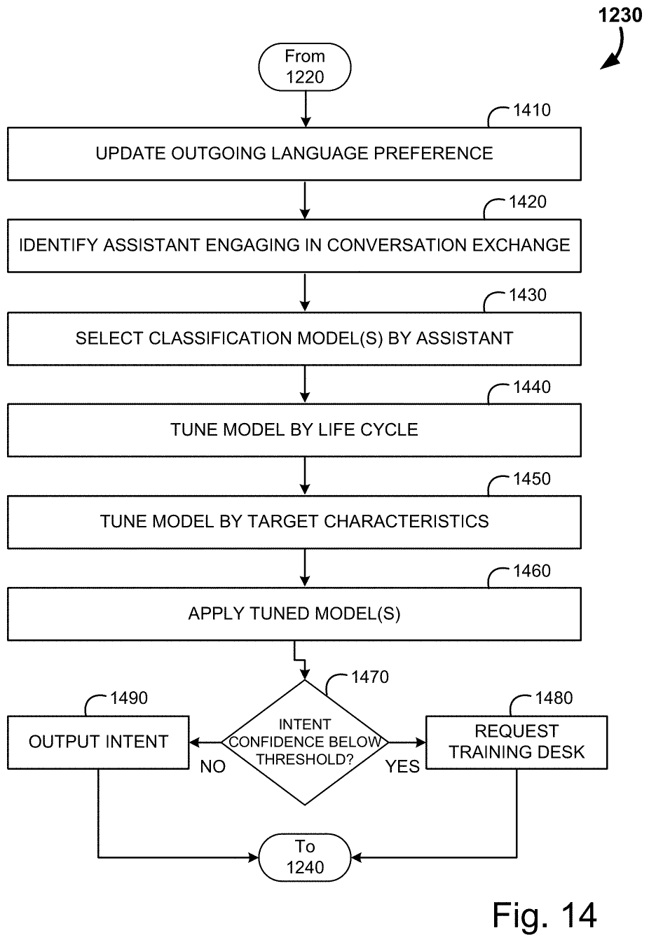

FIG. 14 provides a more detailed view of this classification process setting step 1230. In this example process, the language utilized in the conversation may be initially checked and updated accordingly (at 1410). As noted previously, language selection may be explicitly requested by the target, or may be inferred from the language used thus far in the conversation. If multiple languages have been used in any appreciable level, the system may likewise request a clarification of preference from the target. Lastly, this process may include responding appropriately if a message language is not supported.

After language preference is determined, the system may determine what assistant, among a hierarchy of possible automated assistants, the contact is engaging with (at 1420). Each assistant includes different preferred classification and action response models, personality weights, and access permissions. Thus, a response received by one assistant may be treated significantly differently than that of a second assistant.

The classification models selected may then be influenced by which assistant has been identified (at 1430). The models employed are further tuned by the conversation lifecycle (at 1440) and by the characteristics of the contact (at 1450). This includes adjusting weights for the particular models based upon historic accuracy for the given contact, and altering the weights based upon the stage of conversation.

The thusly tuned models are then applied (at 1460) to the processed response data to generate a series of intents classifications with attendant confidence levels. These confidence measures are then compared against acceptable thresholds (at 1470). Model intent classifications above the necessary thresholds may be directly outputted (at 1490); however lower than needed confidence levels require human intervention via a request from the training desk to review the response (at 1480).

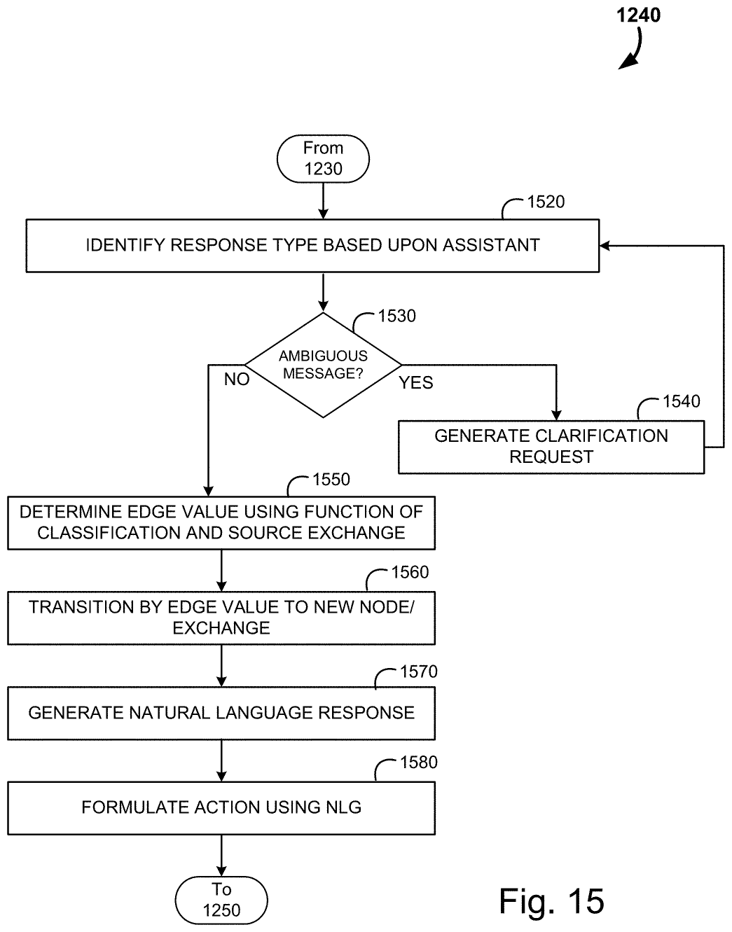

Returning to FIG. 12, after the classification is performed to identify intents and entities within the response, the process may continue with action setting (at 1240). FIG. 15 provides a more detailed view of this action setting step 1240. Initially the response type is identified (at 1520) based upon the message it is responding to (question, versus informational, vs introductory, etc.). Next a determination is made if the response was ambiguous (at 1530). An ambiguous message is one for which a classification can be rendered at a high level of confidence, but which meaning is still unclear due to lack of contextual cues. Such ambiguous messages may be responded to by generating and sending a clarification request (at 1540) and repeating the analysis.

However, if the message is not ambiguous, then the edge value for the exchange may be determined using a function of the classification and the source exchange (at 1550). As noted before, this function may be any combination of deterministic (such as Boolean rules applied to the intents and entities), machine learning approaches for offline policy learning using historical and audit data, and/or reinforced learning approaches such as multi-armed bandit problem.

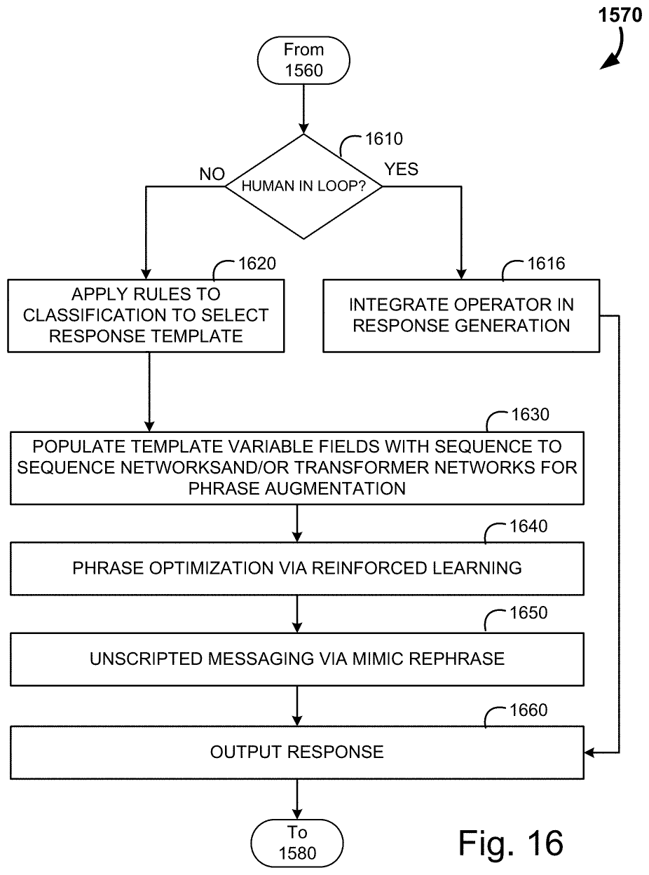

Upon transition to the new exchange state, the transactional assistant can further perform natural language generation (NLG) for the response (at 1570). NLG process is described in greater detail in relation to FIG. 16. NLG may include phrase selection and template population in much the manner already discussed. NLG may likewise include human in the loop (HitL) which integrates with this phrase selection process to curate the outgoing response. Human in the loop is initially determined (at 1610) based upon how confidently the system can generate a viable response. For example, if the target intents are already mapped to a specific set of phrases that have historically been well received and/or approved by a human operator, then there may not be a need for a HitL. However, if the intents are new (or a new combination of intents and entities for the given exchange) then it may be desirable to have human intervention (at 1616).

If the system progresses without human intervention, initially a template is selected related to the classification/intents that were derived from the response (at 1620).

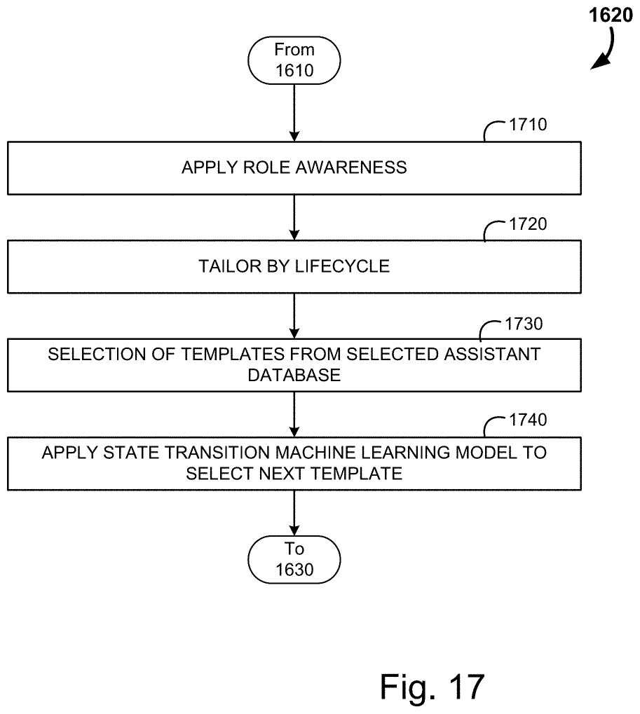

FIG. 17 provides greater detail into one embodiment of this template selection process. Here role awareness is initially applied (at 1710), which weights different templates and/or action models based upon the role of the contact. For example, a contact at a base level position within a procurement division would be treated significantly differently than an Executive Vice President within the same organization. Salutations, message tone, and objective would vary based upon the contact's position/role.

The message templates and phrase selections would likewise be modified based upon conversation lifecycle (at 1720). For example, a message that is early within the conversation exchange will likely be more formal than after the system has developed a “rapport” with the contact. Next, the acceptable message templates are selected from a database of all templates available to the specific assistant the contact is conversing with (at 1730). Finally, from among the available templates, the specific template to apply is selected to transition the conversation from the present state, to a desired next state (at 1740). This selection process includes applying a model to the current state and the chance of shifting to a desired subsequent state, given the lifecycle stage and role awareness modifications. Rules linking the intents, entities, and exchange state may be leveraged for template selection.

Returning to FIG. 16, the template is then populated with phrase selections (at 1630). Sequence to sequence networks and transformer networks may be employed to augment the phrases in a dynamically generated message. Additionally or alternatively, reinforced learning algorithms may be employed for phrase selection (at 1640), and unscripted messages may be generated using mimic rephrasing (at 1650). Population of the variable fields includes replacement of facts and entity fields from the conversation library based upon an inheritance hierarchy. The conversation library is curated and includes specific rules for inheritance along organization levels and degree of access. This results in the insertion of customer/industry specific values at specific place in the outgoing messages, as well as employing different lexica or jargon for different industries or clients. Wording and structure may also be influenced by defined conversation objectives and/or specific data or properties of the specific target.

Specific phrases may be selected based upon weighted outcomes (success ranks). The system calculates phrase relevance scores to determine the most relevant phrases given a lead state, sending template, and message component. Some (not all) of the attributes used to describe lead state are: the client, the conversation, the objective (primary versus secondary objective), series in the conversation, and attempt number in the series, insights, target language and target variables. For each message component, the builder filters (potentially thousands of) phrases to obtain a set of maximum-relevance candidates. In some embodiments, within this set of maximum-relevance candidates, a single phrase is randomly selected to satisfy a message component. As feedback is collected, phrase selection is impacted by phrase performance over time, as discussed previously. In some embodiments, every phrase selected for an outgoing message is logged. Sent phrases are aggregated into daily windows by Client, Conversation, Series, and Attempt. When a response is received, phrases in the last outgoing message are tagged as ‘engaged’. When a positive response triggers another outgoing message, the previous sent phrases are tagged as ‘continue’. The following metrics are aggregated into daily windows: total sent, total engaged, total continue, engage ratio, and continue ratio.

In addition to performance-based selection, as discussed above (but not illustrated here), phrase selection may be influenced by the “personality” of the system for the given conversation. Personality of an AI assistant may not just be set, as discussed previously, but may likewise be learned using machine learning techniques that determines what personality traits are desirable to achieve a particular goal, or that generally has more favorable results.

Message phrase packages are constructed to be tone, cadence, and timbre consistent throughout, and are tagged with descriptions of these traits (professional, firm, casual, friendly, etc.), using standard methods from cognitive psychology. Additionally, in some embodiments, each phrase may include a matrix of metadata that quantifies the degree a particular phrase applies to each of the traits. The system will then map these traits to the correct set of descriptions of the phrase packages and enable the correct packages. This will allow customers or consultants to more easily get exactly the right Assistant personality (or conversation personality) for their company, particular target, and conversation. This may then be compared to the identity personality profile, and the phrases which are most similar to the personality may be preferentially chosen, in combination with the phrase performance metrics. A random element may additionally be incorporated in some circumstances to add phrase selection variability and/or continued phrase performance measurement accuracy. Lastly, the generated language may be outputted (at 1660) for use.

Returning to FIG. 15, after NLG, this language may be used, along with other rule based analysis of intents, to formulate the action to be taken by the system (at 1580). Generally, at a minimum, the action includes the ending of the generated message language back to the target, however the action may additionally include other activities such as attaching a file to the message, setting up an appointment using scheduling software, calling a webhook, or the like.

Returning all the way back to FIG. 12, after the actions are generated, a determination is made whether there is an action conflict (at 1250). Manual review may be needed when such a conflict exists (at 1270). Otherwise, the actions may be executed by the system (at 1260).

Returning then to FIG. 10, after the response has been processed, a determination is made whether to deactivate the target (at 1075). Such a deactivation may be determined as needed when the target requests it. If so, then the target is deactivated (at 1090). If not, the process continues by determining if the conversation for the given target is complete (at 1080). The conversation may be completed when all objectives for the target have been met, or when there are no longer messages in the series that are applicable to the given target. Once the conversation is completed, the target may likewise be deactivated (at 1090).

However, if the conversation is not yet complete, the process may return to the delay period (at 1020) before preparing and sending out the next message in the series (at 1030). The process iterates in this manner until the target requests deactivation, or until all objectives are met. This concludes the main process for a comprehensive messaging conversation.

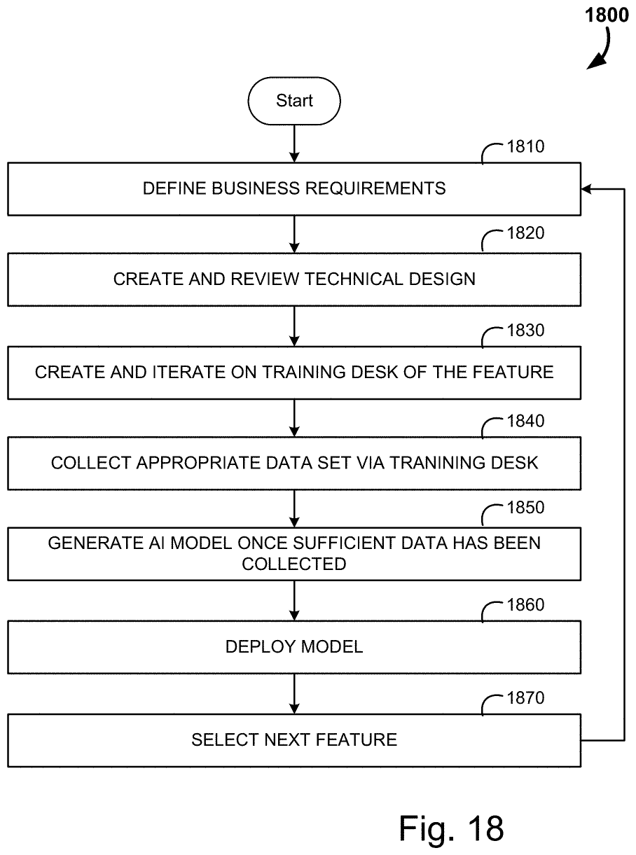

Turning now to FIG. 18, an example process flow diagram is provided for the method of training the AI models, shown generally at 1800. This process begins with the definition of the business requirements (at 1810) for a particular model. A new feature requirement should reflect what the leaders of the organization want to accomplish. This defining of the business requirement ensures that the new feature is responsive to these objectives. For example, if for example a frequently asked question with accepted answers (FAQAA) feature is desired, the business requirement may include that customers are interviewed for the generation of the FAQAA but that the FAQAA can be ‘activated’ without the need for offline communications (minimizing business disruption and added effort).

For example, typically in the industry frequently asked questions are identified and provided by the clients that are fed in the AI system. To reduce the burden on clients to identify right questions and to further provide insight into questions that are being asked by the leads a data-driven approach may be utilized. There are various lead responses that are best informed about the questions that were asked by leads to a particular client. Therefore, (1) the system may process the lead responses to detect the questions, (2) create topics and (3) cluster them into a group of topics that had the same answer. Through such an analysis, it was found that set of refined 11 clusters could answer more than 5000+ questions. These clusters were identified utilizing annotations. This annotation process had two steps. First, the system used a mechanism to merge various topics into the clusters. As a second step, the system gained a refined list of questions per cluster. Subsequently, the clients are provided these clusters and provided the ability to add additional questions to the various clusters, which provides variants to the system, thereby improving system accuracy.

Not only does the system have an ability to extract the questions, but the system exposes to the clients (where rep can answer the client question) to these questions thereby enabling the system to automatically extract not only the question but also learn how to answer a particular question (based on how rep responded). The system uses this mechanism to automatically generate the question-answer pair and will send it to clients for approval. If approved/and modified, this answer becomes as a “approved answer” in the system that is used to generate the answer.

There are situations where the AI is unable to (1) detect the question or (2) is able to positively match the question with a cluster. The system reacts by enabling the training desk/annotators/auditors to “mark a sentence as a question” and apply it to a specific cluster. These questions then are automatically added into the cluster as a question and are detected as a question and is answered appropriately.

A technical design is created and reviewed (at 1820) for the feature of the model. This may initially be performed by an AI developer, but over time may be machine generated based upon reinforced learning. The technical design is presented to the stakeholders. In the FAQAA example, the technical design may include the capability to annotate general question intents.

After which, the feature can be created within the training desk, and iterated upon (at 1830). The training desk includes human operators that receive the response data and provide annotation input, decisions, and other guidance on the “correct” way to handle the response. Selection of which training desk to create for the feature may depend upon user experience design, user interaction testing, and AB testing to optimize the user interface generated for collecting the feature results from the annotators. This training desk activity can be refined to collect the relevant dataset for the given feature modeling (at 1840). This may include hiring additional annotators for the specific feature being processed, or a self-serve training desk with a core team or early initial adopters. Refinement may also include a temporal element to wait for data collection until quality information is being generated.

Once sufficient data (of sufficient quality) has been accumulated, a machine learned model can then be generated (at 1850) and deployed (at 1860). Generally a few thousand positive and negative labels are required to be collected to generate a model of the desired accuracy. Model data collection and deployment are performed using annotation micro services with continuous model development and self-learning. This training process does not end however, after model deployment the system may select an additional feature (at 1870) and repeat the process for this new feature. This may further include generation of a validation set of data, which is comprised of agreed upon data between the audit desk and training desk for responses, as well as responses reviewed within an authority review where there are disagreements between the training desk and the audit desk. Validation sets may be continually updated to only include data for a specific time period (for example the prior 30 days). In addition to this prior period of data, an additional set of older samples are added to the validation set in order to reach a set number of samples (i.e., 200 samples) or a set percentage over the samples collected during the set time period (i.e., 20% over the number of samples collected the 30 days prior).

Different sources of training data may be weighted differently based upon where they are sourced from. For example a training desk sample may be weighted at a first level, audit desk a second level, and where the training desk and audit desk are in agreement at a third level, and response feedback at a fourth range (based upon degree of severity). Authority review data may be set at a fifth weight, and handmade samples may receive a sixth weight. For example, training desk or audit desk alone may be given a weight of 1, whereas these desks in agreement may be weighted at 10. Response feedback may vary between 10 to 20 (i.e., 10, 12, 15 and 20) based upon response severity degree. Authority review may be weighted at 50, and handmade samples may be weighted at 15.

Metrics on the validation data for a new model and old models are then generated. These metrics may include automation rates, accuracy, F1 score, percentage unacceptable matches, and a Conversica score which comprises custom labels from the model (if applicable). This metric data is leveraged to determine when a new model is sufficiently trained to be deployed to replace an older model.

In alternate embodiments, the deployment may be determined by taking a set number of samples that were classified by the old model without human intervention (i.e., 50 samples in some cases). An equal number of samples that were sent to the training desk (no automated) are likewise selected. These samples may be most recent or may be distributed over the period of prior model deployment and when the new model is built. These sampled messages are provided to a review team for annotation. Using self-learning the samples that have thus been reviewed are utilized to train the new model. The above described cross validation techniques are used to determine when the newly generated model is ‘good enough’ for deployment. The accuracy of the new model on the set of samples that were classified by the old model without intervention are compared. Likewise, the automation rate of the new model on the second set of sample (no automation set) is determined. If the new model passes validation checks and performs better than the old model in terms of accuracy and automation rates, then the new model may be passively released first, and after a couple of days passively operating, may replace the older model.

The objective of this feature development activity is that the existence of engineers and computer scientists/developer can be virtually eliminated in such a system over time, and rather all people engaged with the system become users that assist in the system's continued improvement. Essentially, self-improvement is a characteristic of the transactional assistant, thereby ensuring that, over time, fewer and fewer inputs from humans (in the form of annotation events) and developer time (for model construction) occurs. This training methodology is distributed, thereby allowing for faster training process. Additionally, a local mode of operation may be possible to allow for even faster development. Hyperparameter optimization in the distributed and local modes may also be employed to further increase training speed. In some embodiments, the system may include easy extensibility to support other task types as well, such as building word vectors or the like.

Additionally, by allowing each customer to train and deploy their own features, the transactional assistant can be personalized for the given customer. Thus, the operating of the assistant for one company could react very differently than for another company, with all other things being equal. Personalization in such a manner is aided by the ability to readily illustrate to the customer how successful the system is in key metrics. This may include aggregate success metrics, or a deeper dive into specific transactions. By enabling the customer to visualize success of the personalized models they can quickly gain an understanding on the utility offered by the system, the needs of the targets, and can further improve their business operation in response to the conversation results.

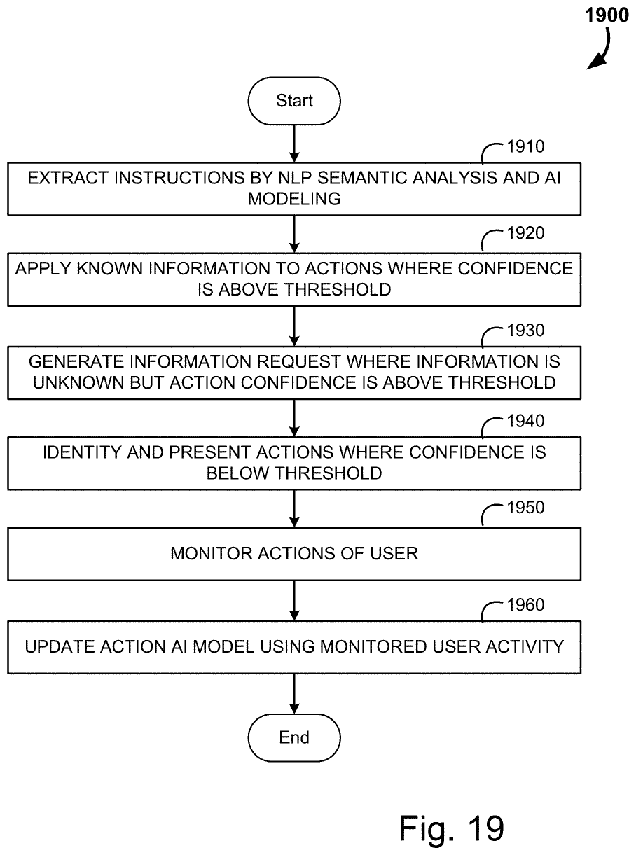

Now turning to FIG. 19, an example process for robotic process automation is provided, shown generally at 1900. The presently disclosed conversational systems are useful as assistants that interact with others, but moreover can provide the ability to automate tasks that historically require user input. In the most fundamental sense, auto-fill of fields on a webpage is an example of such robotic automation. In these systems, user inputted data is saved and associated with a type of field. Generally these include name, address, email and phone number information. More advanced systems may even perform basic section analysis of a resume, for example, and fill in job application fields by copying relevant sections of the resume into the appropriate fields. These systems, however, have very low success rates under any except the most routine situations. They rely entirely upon keyword analysis and a limited dataset of either prior user entered data, or copying of information from one document to the webpage fields. The present systems of insight computation using classification models, and the ability to access large knowledge datasets and perform actions based upon action models, enables for more sophisticated robotic automation of these non-routine tasks.

The present automation process starts by extracting instructions of the task at hand via the NLP semantic analysis disclosed previously (at 1910). This includes classification of the task instructions using various AI models based upon confidence levels. For example, assume a user desires to place an order for a product. The system may log into the procurement system for the supplier and access the language listing instructions for the fields. The system is able to determine where shipping, billing and contact information is requested. These fields include known information, and can be classified very accurately (e.g., greater than 92% accuracy for example). For these inputs, where the information is known and the confidence is high, the system may automatically input the information, or complete the action specified (at 1920).

In other situations the information to answer the question, or to complete the action is not known, but the system may have a high confidence in what is being requested. For these situations, the system can generate, using the above disclosed message generation techniques, a query to provide to the user to assist in completing the form/activity (at 1930). For example, if the system determines, at a high degree of accuracy, that the procurement portal is asking for a quantity of the product, but this number is not known to the system, it may generate a question for the user such as “how many widgets do we want to order?”

The other situation that exists is where the automated activity system is unable to properly determine the proper response to the instruction. This can occur when the classification models' and/or the action response models' confidence levels are below a desired level. For example if the procurement portal states “check here if the product will be subject to export control restrictions” the system may not be capable of accurately classifying such a request. These actions, when identified, are presented directly to the user (at 1940). For situations where the answer/action is suspected, such as between confidence levels of 75-91%, the action may be presented to the user with the ability to select from a list of suspected actions (rather than enter the action directly). Otherwise, for lower confidence activities, the user may simply be requested to input the answer to the question.

When the user inputs answers to these activities, either directly or through the selection of one of the suggestions, the system can monitor these answers (at 1950). This collected input becomes part of the training data utilized by the machine learning to update or refine the AI models for classification and/or action response (at 1960).

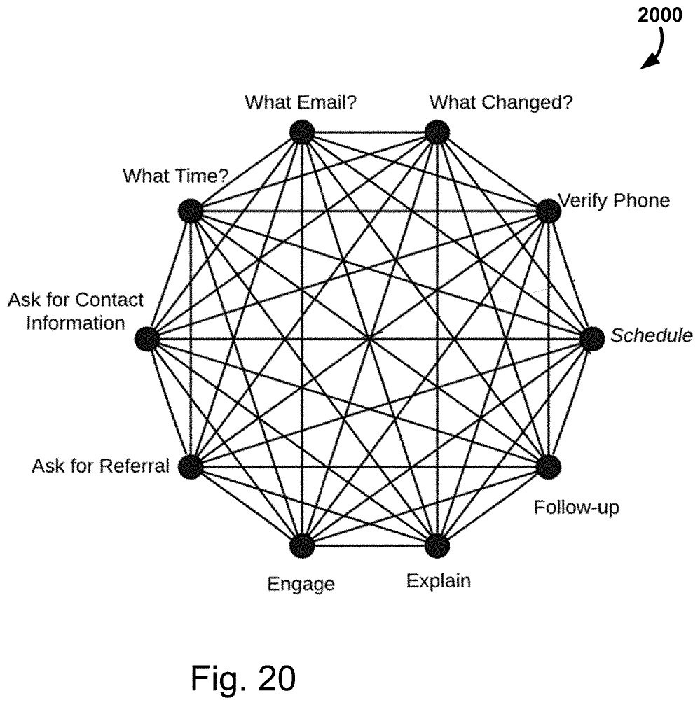

Turning to FIG. 20, and illustration 2000 off an example conversation exchange sets are provided, for explanatory purposes. Each node in this example illustration is an exchange state for the conversation. Each exchange is connected to all other exchanges via bi-directional edges. In this example, ten different conversational exchange states are possible. The NLU results, and the source exchange position, dictate if a shift to another exchange is warranted, and which exchange to transition to. For example, the prior exchange may have been at “what email?” (in this example conversation) and the previous message included an email address and stated “let's set up a meeting”. The derived intent may indicate that the proper edge direction would include transitioning to an exchange for “schedule” of the meeting.

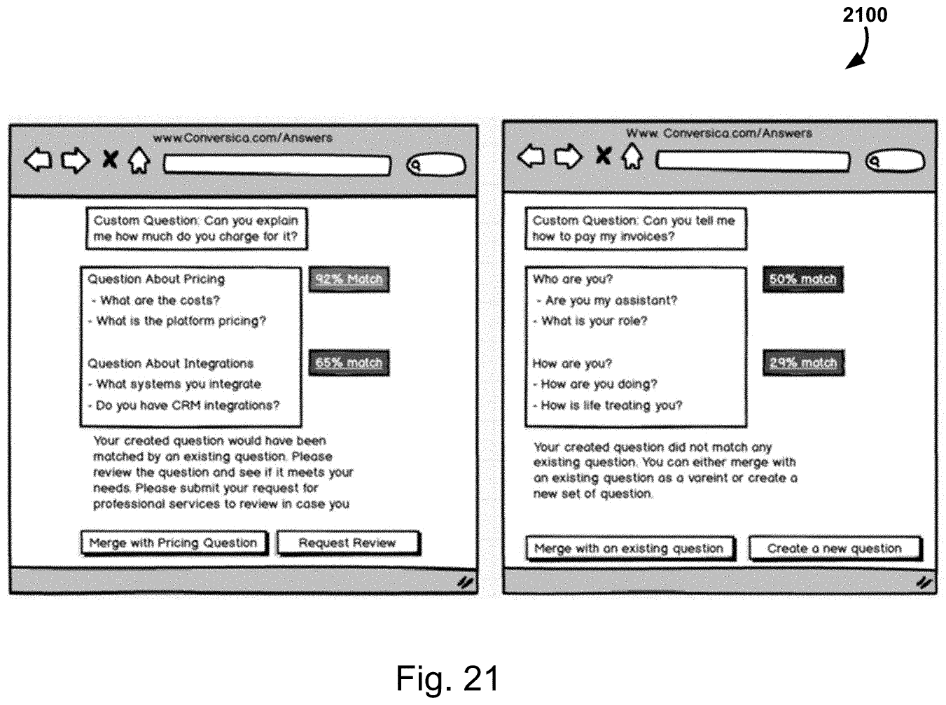

Turning now to FIG. 21, an example illustration 2100 is presented for an interface enabling a customer/user of the dynamic conversation system 108 to create their own business questions/intents and train the AI to respond to it accordingly. This interface also enables a mechanism by which the system is able to resolve conflicts when the added question matches with an existing question category by giving the user the ability to select and make decisions that further resolves the conflicts through policy audits.

In this example set of illustrations, the user is capable of entering in their own custom question. Initially the system will utilize the provided customer data to generate a set of “standard” questions, such as “when are you open?” or “do you carry [product ID]?”. However, in addition to these auto-generated questions, the customer is further enabled to generate specific sets of questions above and beyond the standard set.

Each question, whether standard generated or custom inputted, is then classified using the AI classification modeling previously discussed in significant detail, to provide a percentage match of the question to an existing intent category. Each intent category is composed of variant sets of questions. Any new question needs to be different from the existing variants of existing questions, otherwise it does not provide the AI system any additional information to learn from. To provide this level of visibility, the percentage match with current sets of questions/variants is shown to the user, as seen in this example interface. Additionally, the user is able to either merge their newly created question with an existing category, or generate an entirely new question category if the percentage match is below a threshold (below 90, 80 or 70% for example). Questions that are too similar to existing categories (greater than the threshold level) may also be able to generate a new category, but first require a policy review via an exception request, before such questions can be newly created. In the example illustration, the question “Can you explain me how much do you charge for it?” is matched with a very high confidence percentage (92%) to “Question about pricing” category. If the user does not wish to merge with the existing category, and rather wishes to generate a new question category, a policy review would be required, whereas merging with any existing category would be completed without any policy review and exception.

When a new question category is generated by the user, the user is requested to provide multiple variants of the specific question. The AI modeling requires multiple examples of the question in order to be accurate in its classifications. By providing the multiple variants of the question, the AI model is capable of learning how to match new questions to the category with greater precision. The variants provided by the user are compiled into a consolidated dataset, and the AI system can provide feedback to the user when the dataset includes sufficient variants to enable the model for function within an acceptable level of accuracy.

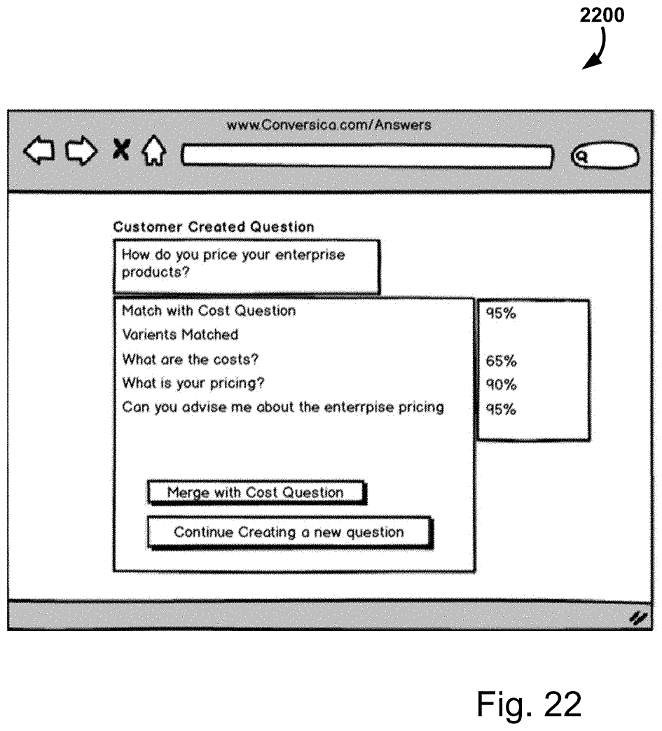

Moving forward, whenever the conversation with a contact includes a question, the classification models may leverage these custom intents (in addition to the standardized intents) to provide user/customer specific message responses. FIG. 22 shows an additional example illustration of an interface 2200 where the percentage match for a newly created intent question is compared against not only the question category, but specific variants within this category.

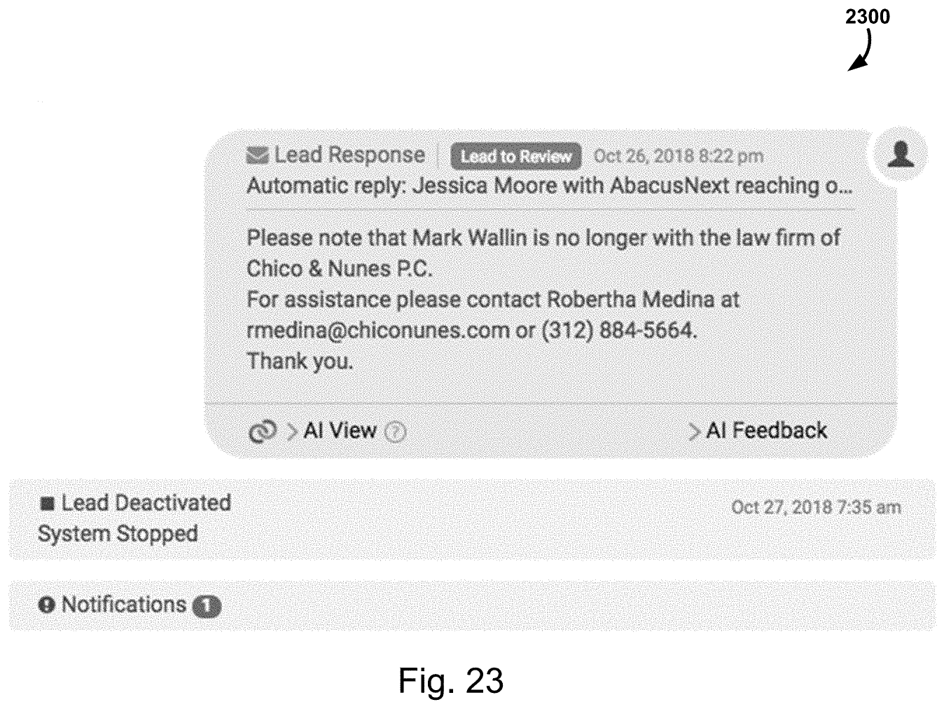

Turning now to FIG. 23, and example illustration of a message 2300 where new contact information is being presented, and initial system actions taken in response are provided. Updating contact information is not a trivial task, and until recently would require user review of the message, and additional user input to actually update a contact's information. This is especially true when the contact update isn't just that a new contact exists, but when the contact is no longer present. In these situations the time taken by the user to review and update the contact information is viewed as “useless” activity, and leads to user frustration and dissatisfaction. The purpose of the dynamic messaging system is to automate tasks to increase the productivity of the user. Thus, the ability for these systems to automatically handle the updates of contact information is likewise preferable.

When a message is received, the system may classify the response in the manner disclosed previously. When the intent classified for includes a contact update, the current contact may be deactivated (as shown here), and a notification of the activity provided to the user. An important additional step taken when the classification indicates that a contact has left the organization is to also parse the message looking for alternate contacts. Empirically, between roughly 20-50% of email messages indicating someone is no longer with the company/organization, include alternative contact information for someone different. Thus the system deactivates the first contact (sets them to a status of ‘disqualified’), updates the conversation stage to ‘contact stopped’, then changing the conversation status to ‘no longer at company’.

It is likewise considered that the contact is still with the company, but is not a proper contact for the message campaign. Examples of this are when the contact does not have authority to speak with the messaging system, or is not the correct division or role. In these cases, the contact status is updated to ‘neutral’, and the conversation stage is set to ‘ask for contact information’ and status as ‘contact to review’ once the old contact supplied the new contact information. The conversation status is set to ‘wrong contact’.

The system parses the message for alternate contact information (using the above described classification modeling). In some embodiments, a new contact is identified when a name and either a phone number or email contact is identified. In some cases, the alternate contact information may be requested. For example, if only a new email is provided, the system may email this new contact and request their name, company, job title and the like. Alternatively, the system may query external systems (LinkedIn, company websites, etc.) to validate the contact. Additionally, the new contact data may be compared against the existing CRM systems employed to ensure there is no contact duplication. If new contact information has been identified and validated in this manner, an alert is sent to the client/user indicating 1) that the previous contact is no longer at the company, and 2) that a new alternate contact was found. This alert asks the client user if a new contact should be created from the alternate contact information that was found. If so, the system may undergo automated contact verification, and automatically starts messaging the new contact. If no additional/alternate contact information was received, based upon the client's configuration, the system may simply deactivate the old message, or may additionally supply the user with a notification of such. Default configurations may be to discontinue without any notification to the client user.

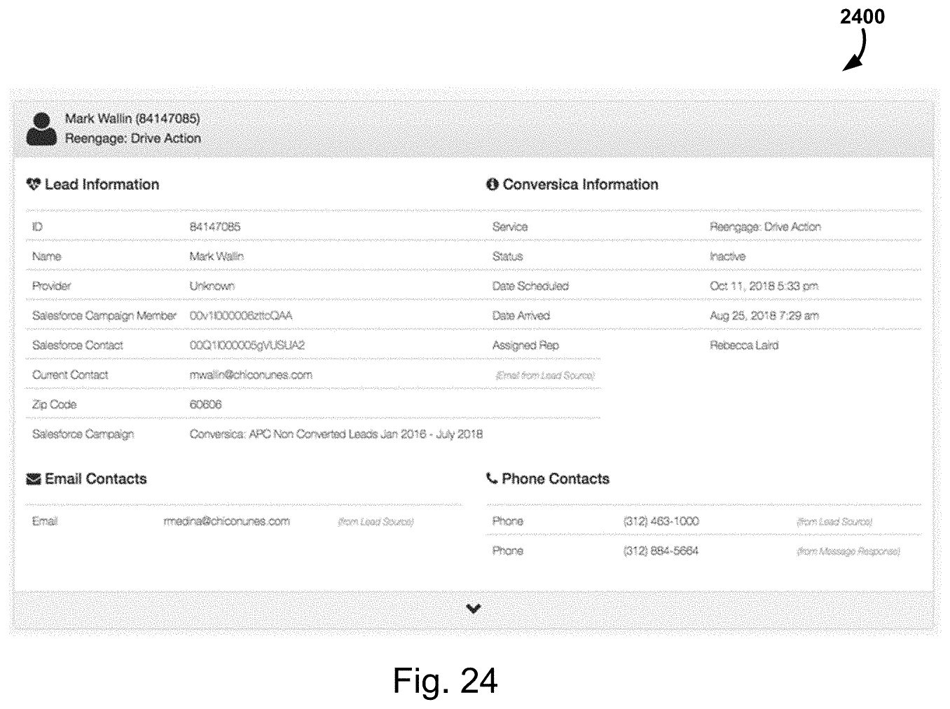

FIG. 24 provides an example illustration of an interface 2400 showing a contact's record. Information pertinent to the contact, such as their name, email, ID number, location and phone number are all included. Likewise, the system may track the contact's status, what message campaign they are engaged in, dates contacted and upcoming message schedule, and the like. This information is what may be updated, and newly created, based upon the existence of a contact deactivation event and the presence of alternate contact information being provided.

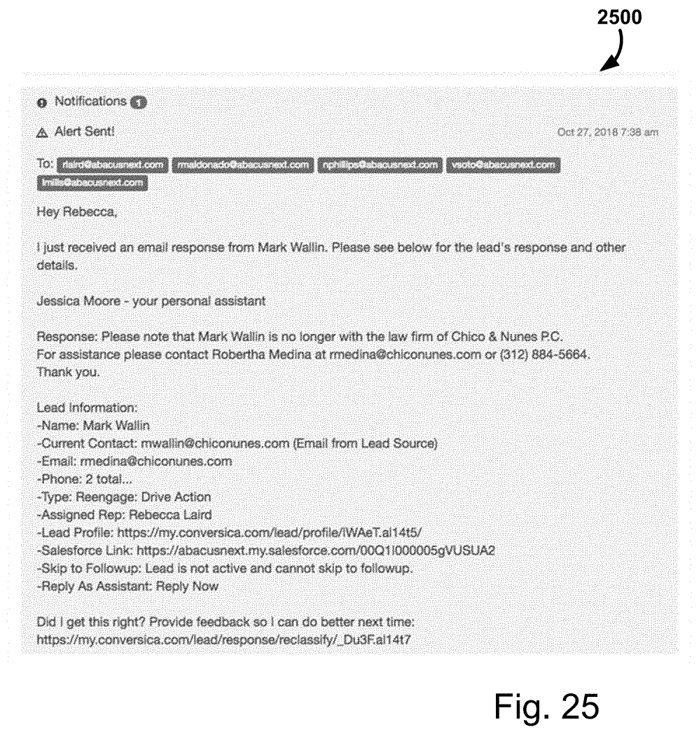

FIG. 25 provides an example illustration of the notification 2500 that is generated in the event of a contact being updated. The alert indicates the deactivation of the original contact, and any additional actions taken. In this example notification it is directed merely to a contact being deactivated, and as such feedback is requested if this action was somehow inappropriate. However, when alternate contact information has been supplied, the system notification may likewise include a hyperlink which allows the user to easily click to have a new contact generated using the identified alternate contact information.

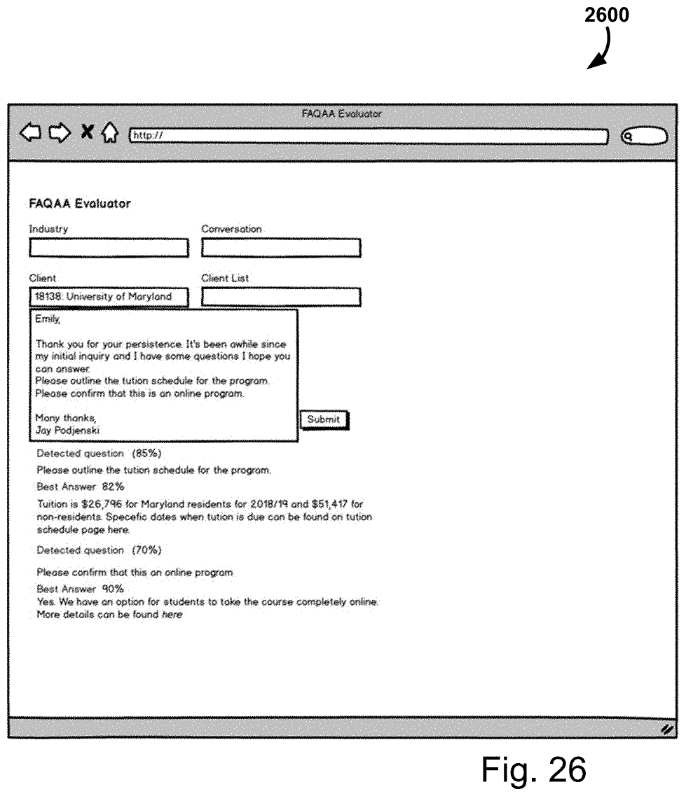

FIG. 26 illustrates and example interface 2600 showing the evaluation of a FAQAA. This system component provides a mechanism to evaluate and demonstrate the FAQAA capability as a diagnostic mechanism. For this evaluator, a client user is requested to write and submit a question (or otherwise copy in a customer/contact response) directly into a field of the evaluator. The user then selects question/answer applicability across different criteria, including industry, conversation, client and client list.

The inputted text is analyzed by the AI model classifiers to detect if a question is present, and subsequently what a suitable answer for the question would be. These are presented back to the user along with the confidence percentages associated with these findings. If no answer is found above a minimum threshold (less than 65, 55, or 50% for example) then the system may respond by stating “no question found” or “no answer found” accordingly.

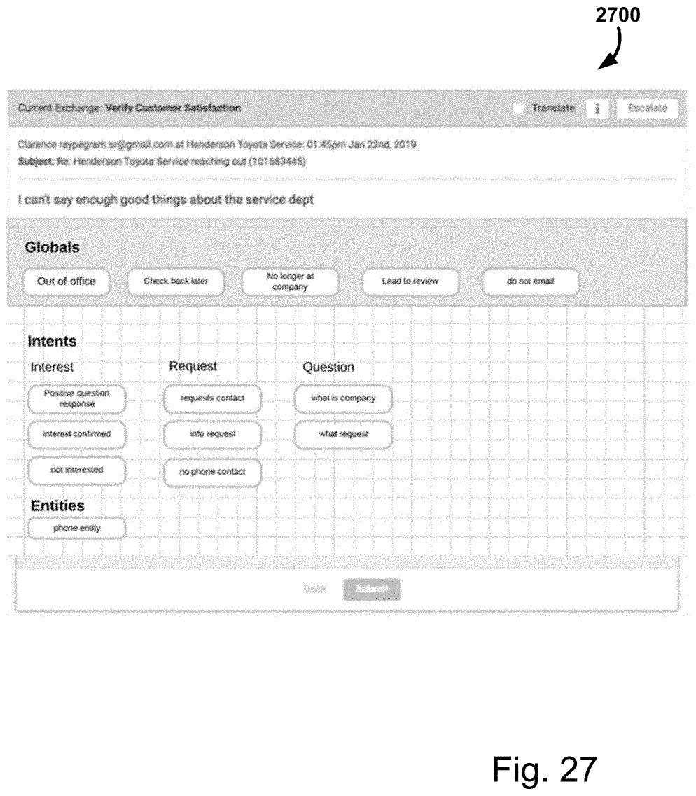

Turning to FIG. 27, an example interface 2700 for the training desk annotator is provided. This example interface is useful for training desk operators that enables annotation of responses to build and update the various AI models, as well as supporting conversation customizability. The training desk relies upon having a human-in-the-loop to support conversations. The training desk directly impacts the relationship between the client users, the contacts conversing, and the AI system/dynamic conversation system. As such, fast and accurate training desk annotations is important for overall system success.

In the present illustrative interface the current exchange status is indicated, along with the conversation subject and the response message (or portion of the response being analyzed). The annotator is presented with global intents to select from, and a series of variable intents and entities. Global intents are available for all messages in all exchanges, and are mutually exclusive. Variable intents and entity selection, in contrast, are exchange dependent, are not mutually exclusive, and are organized by an ontology.

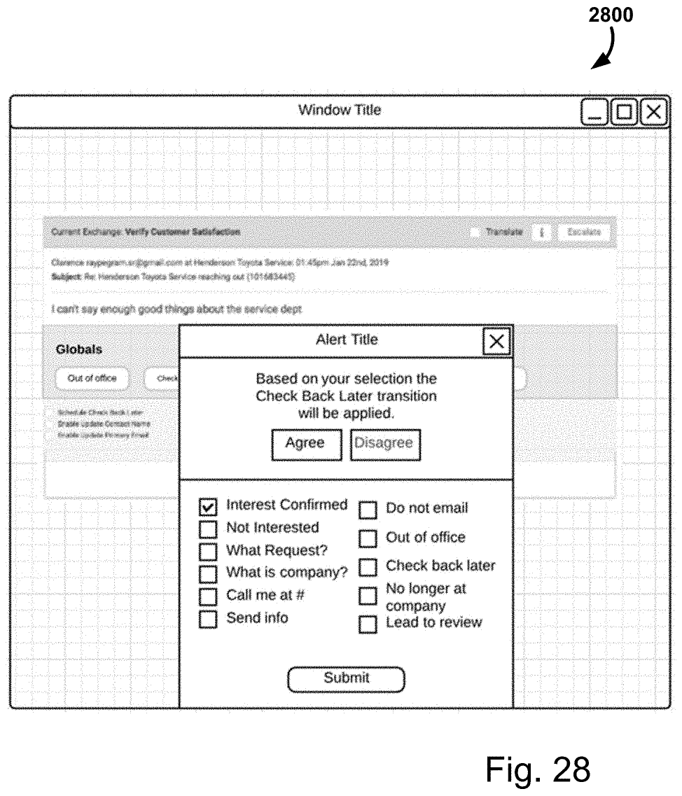

The annotator is able to rapidly select intents, global intents, variable intents and entities and submit them for classification model refinement. These intent selections are used by the system to generate a transition for the exchange using the action response model(s). This transition is then presented to the annotator for agreement or disagreement, as seen in FIG. 28 at the example interface 2800. If agreed to, the transition will occur. If disagreed to, a listing of alternate transitions may be presented to the annotator for selection, and application. The user's input regarding the transition is likewise utilized to update the action response models.

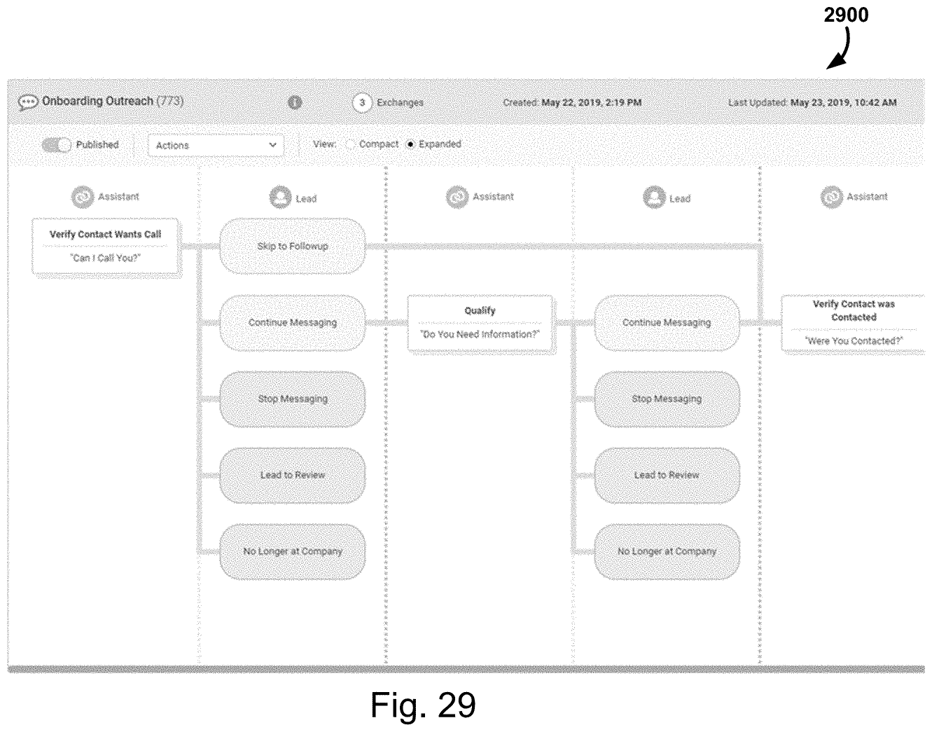

FIG. 29 provides an example illustration of conversation architecture shown in a conversation management platform interface 2900. The management platform facilitates the interactions between the AI driven assistant and the contact. This platform enables multi-turn conversations, in multiple channels, multiple languages, supporting multiple AI assistants with multiple objectives. Using this platform the conversations can be edited and customized at differing levels, including system wide, industry vertical, customer and individual levels. The platform organizes the conversations into “trees” which include the baseline text, input variables from third party systems, such as marketing automations, and CRM systems, synonym variables and phrase packages, time variables, and the like. As noted this conversation tree may be visualized in the interface of the management platform.

Such and interface allows the business to understand the transitions/conversations/AI interactions. Similar to how humans interact, some responses are in-build or obvious and hence uninteresting, where some interactions are more interesting and require attention (that defines how a human behaves). Therefore, the design tenets have considered them while building out conversations. Therefore, transitions that are default/build-ins are hidden from the immediate view.

To manage AI interactions with the end user, the user can visualize options they have for each response obtained from the end user. For each response obtained the user can apply various intents, rules that take different actions. A user has the ability to apply new rules/intent combination. In real time various responses will be present and a user can visualize and see those responses to make a decision on the intended impact of the applied rules and therefore modify and finetune the AI interactions further. These capabilities include AB testing capabilities that test the success of the response given by AI based on understood lead intent. These reactions are measured based on conversation rates, engagement etc.

An AI can potentially interact with millions of leads/targets at the same time. As the complexity of the system increases business user should have an ability to visualize the trends of incoming traffic in terms of intents, and traffic. The system allows the end-user to visualize how the incoming lead responses/interactions are trending in real time. Therefore, the end user can prioritize which rules to create, and which traffic and transitions to manage.

Further, the business needs ability to categorize what a lead interaction meant and so that they can review and manage the responses. The interface allows business users to bucket leads in various group. To this end they can, for example, assign a lead a “hot lead” or “lead that requires Further action” based on the response received and therefore the rules/transitions taken. This helps the end user to better manage the AI and lead interactions.

### III. System Embodiments

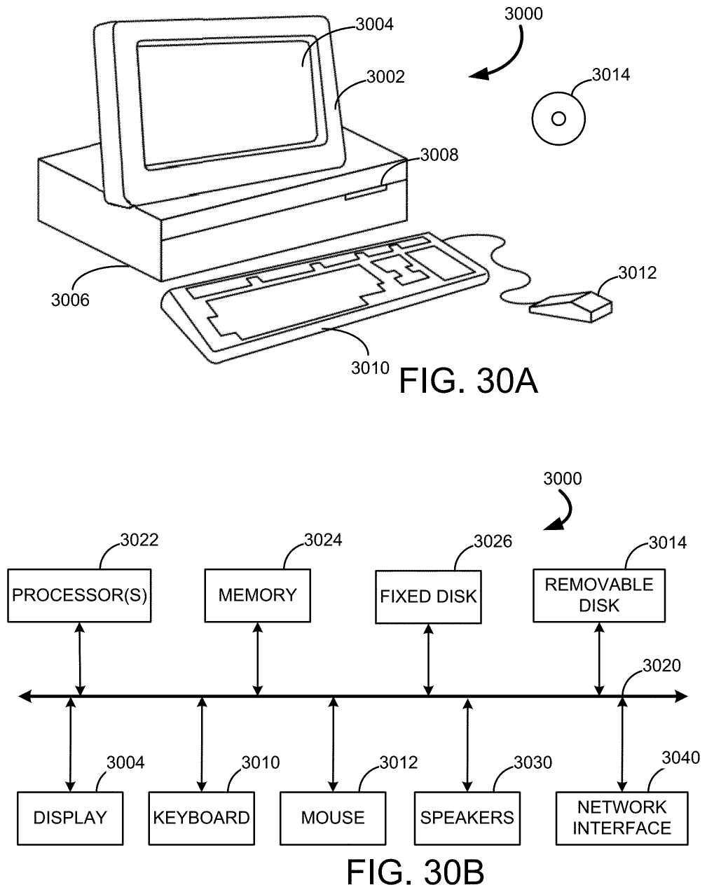

Now that the systems and methods for the conversation generation with improved functionalities have been described, attention shall now be focused upon systems capable of executing the above functions. To facilitate this discussion, FIGS. 30A and 30B illustrate a Computer System 3000, which is suitable for implementing embodiments of the present invention. FIG. 30A shows one possible physical form of the Computer System 3000. Of course, the Computer System 3000 may have many physical forms ranging from a printed circuit board, an integrated circuit, and a small handheld device up to a huge super computer. Computer system 3000 may include a Monitor 3002, a Display 3004, a Housing 3006, a Storage Drive 3008, a Keyboard 3010, and a Mouse 3012. Storage 3014 is a computer-readable medium used to transfer data to and from Computer System 3000.

FIG. 30B is an example of a block diagram for Computer System 3000. Attached to System Bus 3020 are a wide variety of subsystems. Processor(s) 3022 (also referred to as central processing units, or CPUs) are coupled to storage devices, including Memory 3024. Memory 3024 includes random access memory (RAM) and read-only memory (ROM). As is well known in the art, ROM acts to transfer data and instructions uni-directionally to the CPU and RAM is used typically to transfer data and instructions in a bi-directional manner. Both of these types of memories may include any suitable of the computer-readable media described below. A Fixed Storage 3026 may also be coupled bi-directionally to the Processor 3022; it provides additional data storage capacity and may also include any of the computer-readable media described below. Fixed Storage 3026 may be used to store programs, data, and the like and is typically a secondary storage medium (such as a hard disk) that is slower than primary storage. It will be appreciated that the information retained within Fixed Storage 3026 may, in appropriate cases, be incorporated in standard fashion as virtual memory in Memory 3024. Removable Storage 3014 may take the form of any of the computer-readable media described below.

Processor 3022 is also coupled to a variety of input/output devices, such as Display 3004, Keyboard 3010, Mouse 3012 and Speakers 3030. In general, an input/output device may be any of: video displays, track balls, mice, keyboards, microphones, touch-sensitive displays, transducer card readers, magnetic or paper tape readers, tablets, styluses, voice or handwriting recognizers, biometrics readers, motion sensors, brain wave readers, or other computers. Processor 3022 optionally may be coupled to another computer or telecommunications network using Network Interface 3040. With such a Network Interface 3040, it is contemplated that the Processor 3022 might receive information from the network or might output information to the network in the course of performing the above-described dynamic messaging processes. Furthermore, method embodiments of the present invention may execute solely upon Processor 3022 or may execute over a network such as the Internet in conjunction with a remote CPU that shares a portion of the processing.

Software is typically stored in the non-volatile memory and/or the drive unit. Indeed, for large programs, it may not even be possible to store the entire program in the memory. Nevertheless, it should be understood that for software to run, if necessary, it is moved to a computer readable location appropriate for processing, and for illustrative purposes, that location is referred to as the memory in this disclosure. Even when software is moved to the memory for execution, the processor will typically make use of hardware registers to store values associated with the software, and local cache that, ideally, serves to speed up execution. As used herein, a software program is assumed to be stored at any known or convenient location (from non-volatile storage to hardware registers) when the software program is referred to as “implemented in a computer-readable medium.” A processor is considered to be “configured to execute a program” when at least one value associated with the program is stored in a register readable by the processor.

In operation, the computer system 3000 can be controlled by operating system software that includes a file management system, such as a storage operating system. One example of operating system software with associated file management system software is the family of operating systems known as Windows® from Microsoft Corporation of Redmond, Wash., and their associated file management systems. Another example of operating system software with its associated file management system software is the Linux operating system and its associated file management system. The file management system is typically stored in the non-volatile memory and/or drive unit and causes the processor to execute the various acts required by the operating system to input and output data and to store data in the memory, including storing files on the non-volatile memory and/or drive unit.

Some portions of the detailed description may be presented in terms of algorithms and symbolic representations of operations on data bits within a computer memory. These algorithmic descriptions and representations are the means used by those skilled in the data processing arts to most effectively convey the substance of their work to others skilled in the art. An algorithm is, here and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

The algorithms and displays presented herein are not inherently related to any particular computer or other apparatus. Various general-purpose systems may be used with programs in accordance with the teachings herein, or it may prove convenient to construct more specialized apparatus to perform the methods of some embodiments. The required structure for a variety of these systems will appear from the description below. In addition, the techniques are not described with reference to any particular programming language, and various embodiments may, thus, be implemented using a variety of programming languages.

In alternative embodiments, the machine operates as a standalone device or may be connected (e.g., networked) to other machines. In a networked deployment, the machine may operate in the capacity of a server or a client machine in a client-server network environment or as a peer machine in a peer-to-peer (or distributed) network environment.

The machine may be a server computer, a client computer, a virtual machine, a personal computer (PC), a tablet PC, a laptop computer, a set-top box (STB), a personal digital assistant (PDA), a cellular telephone, an iPhone, a Blackberry, a processor, a telephone, a web appliance, a network router, switch or bridge, or any machine capable of executing a set of instructions (sequential or otherwise) that specify actions to be taken by that machine.

While the machine-readable medium or machine-readable storage medium is shown in an exemplary embodiment to be a single medium, the term “machine-readable medium” and “machine-readable storage medium” should be taken to include a single medium or multiple media (e.g., a centralized or distributed database, and/or associated caches and servers) that store the one or more sets of instructions. The term “machine-readable medium” and “machine-readable storage medium” shall also be taken to include any medium that is capable of storing, encoding or carrying a set of instructions for execution by the machine and that cause the machine to perform any one or more of the methodologies of the presently disclosed technique and innovation.

In general, the routines executed to implement the embodiments of the disclosure may be implemented as part of an operating system or a specific application, component, program, object, module or sequence of instructions referred to as “computer programs.” The computer programs typically comprise one or more instructions set at various times in various memory and storage devices in a computer, and when read and executed by one or more processing units or processors in a computer, cause the computer to perform operations to execute elements involving the various aspects of the disclosure.

Moreover, while embodiments have been described in the context of fully functioning computers and computer systems, those skilled in the art will appreciate that the various embodiments are capable of being distributed as a program product in a variety of forms, and that the disclosure applies equally regardless of the particular type of machine or computer-readable media used to actually effect the distribution

While this invention has been described in terms of several embodiments, there are alterations, modifications, permutations, and substitute equivalents, which fall within the scope of this invention. Although sub-section titles have been provided to aid in the description of the invention, these titles are merely illustrative and are not intended to limit the scope of the present invention. It should also be noted that there are many alternative ways of implementing the methods and apparatuses of the present invention. It is therefore intended that the following appended claims be interpreted as including all such alterations, modifications, permutations, and substitute equivalents as fall within the true spirit and scope of the present invention.

What is claimed is:

1. A method for generating custom client intents in an AI driven conversation system comprising:
receiving data for the client;
auto-generating a series of standard intent categories responsive to the client data;
receiving a custom question from the client;
classifying the custom question to the standard intent categories using at least one AI classification models, wherein the classifying calculates a percentage confidence of a match between the custom question and the intent categories;
displaying the classification results along with the percentage confidence to the client; and
receiving feedback from the client to either merge the custom question with one of the standard intent categories or generate a new intent category.

2. The method of claim 1, wherein merging the custom question with one of the standard intent categories updates the AI classification models as an additional training variant for machine learning.

3. The method of claim 1, further comprising comparing the percentage confidence to a threshold.

4. The method of claim 3, wherein the threshold is 90%.

5. The method of claim 3, wherein the threshold is 80%

6. The method of claim 3, wherein the threshold is 70%

7. The method of claim 3, wherein the threshold is between 65 to 92%.

8. The method of claim 3, wherein when the feedback is to create a new intent category, generating the new intent category when the confidence percentage is below the threshold, and requesting a policy exception when the confidence percentage at or above the threshold.

9. The method of claim 8, wherein the policy exception requires policy review by a data scientist.

10. The method of claim 1, further comprising generating the new intent category responsive to the feedback.

11. The method of claim 10, further comprising requiring the client to provide a dataset of variants for the new intent category as a dataset.

12. The method of claim 11, further comprising providing the client feedback when the dataset is sufficient.

13. The method of claim 12, wherein the sufficiency of the dataset is based upon at least one of the number of variants in the dataset, and the degree of factor difference between the various variants.

14. The method of claim 11, further comprising training the AI models for the new intent category using the dataset.

15. The method of claim 10, further comprising:
receiving a message from a contact;
classifying the message against the standard intent categories and the new intent categories; and
generating a response for the message responsive to the classification

16. A method for contact updating in a conversation between an original contact and a dynamic messaging system comprising:
receiving a response message;
classifying the response message using at least one AI model, wherein the classifying indicates the original contact is no longer with an organization;
deactivating a record for the original contact;
updating a conversation stage to ‘contact stopped’;
updating a conversation status to ‘no longer with company’;
parsing the response message for an alternate contact information; and
when alternate contact information is present sending a notification to a client user informing that the original contact is no longer with company and that alternate contact information was found.

17. The method of claim 16, further comprising receiving feedback from the client user that a new contact should be created.

18. The method of claim 16, further comprising generating the new contact using the alternate contact information.

19. The method of claim 18, further comprising validating the new contact.

20. The method of claim 18, further comprising messaging the new contact.

21. The method of claim 16, further comprising, responsive to a configuration by the client user, notifying the client user of the contact disqualification when no alternate contact information is found.
